(19) United States
(12) Patent Application Publication
(10) Pub. No.: US 2010/0325733 A1
(43) Pub. Date: Dec. 23, 2010

(54) INFORMATION PROCESSING DEVICE, INFORMATION PROCESSING METHOD AND PROGRAM

(76) Inventor: Atsushi Honda, Tokyo (JP)

Correspondence Address: Mr. Jackson Chen, 6535 N. STATE HWY 161, IRVING, TX, 75039, US

(21) Appl. No.: 12/526,347

(22) PCT Filed: Feb. 22, 2008
(86) PCT No.: PCT/JP2008/053070

§ 371 Date: Aug. 7, 2009

(30) Foreign Application Priority Data
Feb. 22, 2007 (JP) 2007-041711

(51) Int. Cl. G06F 21/22; G06F 9/40; G06F 12/14

(52) U.S. Cl. 726/26

(57) ABSTRACT

Hindrance of normal execution of a process caused by unexpected processing of a signal handler can be prevented.

When an instruction 1121 arranged in a function 1125 which might allow unexpected processing of a signal handler to prevent normal execution of a process is executed, a signal handler table of the process is changed to make a signal handler executed during the processing of the function 1125 be a signal handler hook function. When a signal is generated to execute the signal handler hook function, unexpected processing of the signal handler is prevented by executing an original signal handler after changing a security level of the process to a security level not allowed to execute unexpected processing. For ending the function 1125, a second specific instruction 1122 is executed to return the signal handler table to a former state.

### TECHNICAL FIELD

The present invention relates to an information processing device having a function of changing a security level of an application process and, more particularly, a method and a device for changing a security level of an application process when executing a signal handler.

### BACKGROUND ART

In recent years, developed aiming at ensuring security of an information processing device is a secure OS which enables a security level to be set on a process basis such as SE Linux. Also as recited in Patent Literature 1, a security level of an application process is changed dynamically during execution of the process. Here, a security level is one of process attributes, which is an attribute for use in determining whether to allow an instruction or access control to a resource that is executed by the process.

The information processing device is also designed such that when a signal is generated during the execution of a process, a signal handler registered by the process is executed. Signal here is inter-process communication, and when a user or other process causes a specific event, a kind of signal according to the generated event is sent to the process in question. Signal handler is a routine prepared by each process, and a relevant signal handler is executed according to a kind of a received signal. When the process fails to define a signal handler relevant to the received signal, OS executes processing defined in advance. A set of a kind of signal and a signal handler as a pair will be referred to as a signal handler table, which is defined on a process basis. When a signal is generated, OS refers to a signal handler table of a signal transmission destination process to start execution of a signal handler to be paired with the kind of the transmitted signal. At this time, processing of the process which has been executed so far is temporarily interrupted.

Patent Literature 1: Japanese Patent Laying-Open No. 2001-249848.

Since an OS enabling a security level to be set on a process basis eliminates the possibility of alternation, when a process executes a function whose reliability is high, increasing a security level of the process enables a privileged instruction to be executed within the function. Conversely when the process executes a routine whose reliability is low, such control is possible as preventing unauthorized processing by changing a security level of the process.

When during the execution of a function whose reliability is high, a signal is generated to execute a signal handler defined in advance in a process, however, the signal handler is executed without changing a security level. Therefore, normal execution of a function might be hindered by unexpected processing of the signal handler to make it impossible to ensure original processing and in some cases, to invite unauthorized processing. The reason is that depending on a part of a function interrupted by a signal and a kind of privileged instruction executed in the signal handler, it is possible that the processing defined in the function will not be executed according to the definition.

For preventing such unauthorized processing, it is necessary to execute signal handler with a security level of a process changed. The above-described secure OS, however, fails to have a function of detecting a point at which a process starts execution of a signal handler and a point at which the same ends the execution and changing a security level of the process. Therefore, a security level of a process cannot be changed exclusively when a signal handler is in execution.

As to a signal handler to be executed with a security level changed, it is convenient to limit to a signal handler to be executed by a signal which is received while a section subjected to an effect of unauthorized processing by a signal handler is being processed. The reason is that since if all the signal handlers are executed with their security levels changed, processing of the signal handlers might not be executed all the time, it is desirable to minimize execution of a signal handler with a security level changed. There, however, exists no mechanism of determining, when executing a signal handler, which section of the process is being processed by the signal handler when the signal which executes the signal handler is received. It is therefore impossible to change a security level of a process exclusively when a specific signal handler is being executed.

### OBJECTS OF THE INVENTION

An object of the present invention is to enable a security level of a process to be changed when a signal handler is executed.

Another object of the present invention is to detect a signal handler to be executed by a signal received while a process is executing a specific processing section and execute the detected signal handler with a security level of the process changed.

### SUMMARY

According to an exemplary aspect of the invention, an information processing device which executes a process under the control of an OS, comprises

a storage device which holds a function for executing a first specific instruction before execution of a processing section whose normal execution might be hindered by unexpected processing of a signal handler and executing a second specific instruction after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table of a process, and a signal handler storing unit for saving a pair of an attribute value of a process and a signal handler table,

a signal handler changing unit for saving, when the process executes the first specific instruction, a pair of an identifier of the process and the signal handler table into the signal handler storing unit to change the signal handler set at the signal handler table of the process to the signal handler hook function,

a signal handler returning unit for returning, when the process executes the second specific instruction, the signal handler hook function set at the signal handler table of the process to the signal handler as of before setting of the signal handler hook function which is saved in the signal handler storing unit,

a signal handler obtaining unit for obtaining, when the process executes the third specific instruction, a signal handler to be paired with an identifier of the process and a kind of signal received by the process with reference to the signal handler storing unit,

a security level changing unit for changing the attribute value of the process after acquisition of a signal handler by the signal handler obtaining unit, and

a security level returning unit for changing the attribute value of the process to an attribute value as of before change when the process executes the fourth specific instruction.

According to another exemplary aspect of the invention, an information processing device which executes a process under the control of an OS, comprises

a storage device which holds a function for executing a first specific instruction before execution of a processing section whose normal execution might be hindered by unexpected processing of a signal handler and executing a second specific instruction after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table shared by a plurality of processes, and a signal handler storing unit for saving a pair of a process identifier group including an identifier of a process and a signal handler table,

a signal handler changing unit for, when a specific process among a plurality of processes sharing the signal handler table executes the first specific instruction, if no process identifier group including an identifier of other process is stored in the signal handler storing unit, after saving a pair of a process identifier group including an identifier of the specific process and the signal handler table into the signal handler storing unit, changing the signal handler set at the signal handler table to the signal handler hook function, and if a process identifier group including the identifier of the other process is stored in the signal handler storing unit, adding the identifier of the specific process to the process identifier group including the identifier of the other process, as well as adding the signal handler set at the signal handler table to a signal handler table in the signal handler storing unit which table is to be paired with the added process identifier group and thereafter changing the signal handler set at the signal handler table to the signal handler hook function,

a signal handler returning unit for, when the specific process executes the second specific instruction, if no process identifier group including an identifier of the other process is stored in the signal handler storing unit, after returning a signal handler for which the signal handler hook function is set in the signal handler table of the specific process to the signal handler as of before setting of the signal handler hook function which is saved in the signal handler storing unit, deleting data of a pair of a process identifier group including an identifier of the specific process and the signal handler table from the signal handler storing unit, and if a process identifier group including the identifier of the other process is stored in the signal handler storing unit, adding the signal handler set at the signal handler table of the specific process to a signal handler table in the signal handler storing unit which table is to be paired with the process identifier group to delete the identifier of the specific process from the process identifier group,

a signal handler obtaining unit for obtaining, when the process executes the third specific instruction, a signal handler to be paired with an identifier of the process and a kind of signal received by the process with reference to the signal handler storing unit,

a security level changing unit for changing the attribute value of the process after acquisition of a signal handler by the signal handler obtaining unit, and a security level returning unit for changing the attribute value of the process to an attribute value as of before change when the process executes the fourth specific instruction.

According to another exemplary aspect of the invention, an information processing method of executing a process under the control of an OS by an information processing device, wherein

the information processing device holds, in a storage device, a function for executing a first specific instruction before execution of a processing section whose normal execution might be hindered by unexpected processing of a signal handler and executing a second specific instruction immediately after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table of a process, and a signal handler storing unit for saving a pair of an attribute value of a process and a signal handler table, the method comprising

a signal handler changing step of saving, when the process executes the first specific instruction, a pair of an identifier of the process and the signal handler table into the signal handler storing unit to change the signal handler set at the signal handler table of the process to the signal handler hook function,

a signal processing step of determining a signal handler corresponding to a signal received during execution of the process with reference to the signal handler table and when the determined signal handler is the signal handler hook function, calling up the signal handler hook function,

a signal handler obtaining step of obtaining, when the process executes the third specific instruction of the signal handler hook function, a signal handler to be paired with an identifier of the process and a kind of signal received at the process with reference to the signal handler storing unit,

a security level changing step of changing the attribute value of the process after acquisition of a signal handler at the signal handler obtaining step;

a security level returning step of changing, when the process executes the fourth specific instruction after executing the signal handler obtained at the signal handler obtaining step in the signal handler hook function, the attribute value of the process to an attribute value as of before change, and

a signal handler returning step of returning, when the process executes the second specific instruction of the function, the signal handler hook function set at the signal handler table of the process to the signal handler as of before setting of the signal handler hook function saved in the signal handler storing unit.

According to another exemplary aspect of the invention, an information processing method of executing a process under the control of an OS by an information processing device, wherein

the information processing device holds, in a storage device, a function for executing a first specific instruction before execution of a processing section whose normal execution might be hindered by unexpected processing of a signal handler and executing a second specific instruction immediately after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table shared by a plurality of processes, and a signal handler storing unit for saving a pair of a process identifier group including an identifier of a process and a signal handler table, the method comprising

a signal handler changing step of, when a specific process among a plurality of processes sharing the signal handler table executes the first specific instruction, if no process identifier group including an identifier of other process is stored in the signal handler storing unit, after saving a pair of a process identifier group including an identifier of the specific process and the signal handler table into the signal handler storing unit, changing the signal handler set at the signal handler table to the signal handler hook function, and if a process identifier group including the identifier of the other process is stored in the signal handler storing unit, adding the identifier of the specific process to the process identifier group including the identifier of the other process, as well as adding the signal handler set at the signal handler table to a signal handler table in the signal handler storing unit which table is to be paired with the added process identifier group and thereafter changing the signal handler set at the signal handler table to the signal handler hook function,

a signal processing step of determining a signal handler corresponding to a signal received during execution of the process with reference to the signal handler table and when the determined signal handler is the signal handler hook function, calling up the signal handler hook function,

a signal handler obtaining step of obtaining, when the process executes the third specific instruction of the signal handler hook function, a signal handler to be paired with an identifier of the process and a kind of signal received by the process with reference to the signal handler storing unit,

a security level changing step of changing the attribute value of the process after acquisition of a signal handler at the signal handler obtaining step, and

a signal handler returning step of returning, when the specific process executes the second specific instruction, if no process identifier group including an identifier of the other process is stored in the signal handler storing unit, after returning a signal handler for which the signal handler hook function is set in the signal handler table of the first process to the signal handler as of before setting of the signal handler hook function which is saved in the signal handler storing unit, deleting data of a pair of a process identifier group including an identifier of the first process and the signal handler table from the signal handler storing unit, and if a process identifier group including an identifier of the second process is stored in the signal handler storing unit, adding the signal handler set at the signal handler table of the specific process to a signal handler table in the signal handler storing unit which table is to be paired with the process identifier group to delete the identifier of the specific process from the process identifier group.

According to another exemplary aspect of the invention, a program implemented in an information processing device which executes a process under the control of an OS, wherein

the information processing device includes a storage device holding a function for executing a first specific instruction before execution of a processing section whose normal execution might be hindered by unexpected processing of a signal handler and executing a second specific instruction immediately after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table of a process, and a signal handler storing unit for saving a pair of an attribute value of a process and a signal handler table, wherein

the program causing the information processing device to execute processing of

a signal handler changing processing of saving, when the process executes the first specific instruction, a pair of an identifier of the process and the signal handler table into the signal handler storing unit to change the signal handler set at the signal handler table of the process to the signal handler hook function,

a signal handler returning processing of returning, when the process executes the second specific instruction, the signal handler hook function set at the signal handler table of the process to the signal handler as of before setting of the signal handler hook function saved in the signal handler storing unit,

a signal handler obtaining processing of obtaining, when the process executes the third specific instruction, a signal handler to be paired with an identifier of the process and a kind of signal received by the process with reference to the signal handler storing unit;

a security level changing processing of changing the attribute value of the process after acquisition of a signal handler by the signal handler obtaining processing, and

a security level returning processing of changing, when the process executes the fourth specific instruction, the attribute value of the process to an attribute value as of before change.

According to another exemplary aspect of the invention, a program implemented in an information processing device which executes a process under the control of an OS, wherein

the information processing device includes a storage device holding a function for executing a first specific instruction before execution of a processing section whose normal execution might be hindered by unexpected processing of a signal handler and executing a second specific instruction immediately after execution of the processing section, a signal handler hook function for executing a third specific instruction, executing a signal handler starting at an address obtained by the third specific instruction and executing a fourth specific instruction after execution of the signal handler, the signal handler, an attribute value of a process, a signal handler table shared by a plurality of processes, and a signal handler storing unit for saving a pair of a process identifier group including an identifier of a process and a signal handler table, wherein

the program causing the information processing device to execute processing of

a signal handler changing processing of, when a specific process among a plurality of processes sharing the signal handler table executes the first specific instruction, if no process identifier group including an identifier of other process is stored in the signal handler storing unit, after saving a pair of a process identifier group including an identifier of the specific process and the signal handler table into the signal handler storing unit, changing the signal handler set at the signal handler table to the signal handler hook function, and if a process identifier group including the identifier of the other process is stored in the signal handler storing unit, adding the identifier of the specific process to the process identifier group including the identifier of the other process, as well as adding the signal handler set at the signal handler table to a signal handler table in the signal handler storing unit which table is to be paired with the added process identifier group and thereafter changing the signal handler set at the signal handler table to the signal handler hook function,

a signal handler returning processing of, when the specific process executes the second specific instruction, if no process identifier group including an identifier of the other process is stored in the signal handler storing unit, after returning a signal handler for which the signal handler hook function is set in the signal handler table of the specific process to the signal handler as of before setting of the signal handler hook function which is saved in the signal handler storing unit, deleting data of a pair of a process identifier group including an identifier of the specific process and the signal handler table from the signal handler storing unit, and if a process identifier group including the identifier of the other process is stored in the signal handler storing unit, adding the signal handler set at the signal handler table of the specific process to a signal handler table in the signal handler storing unit which table is to be paired with the process identifier group to delete the identifier of the specific process from the process identifier group,

a signal handler obtaining processing of obtaining, when the process executes the third specific instruction, a signal handler to be paired with an identifier of the process and a kind of signal received by the process with reference to the signal handler storing unit,

a security level changing processing of changing the attribute value of the process after acquisition of a signal handler by the signal handler obtaining processing, and a security level returning processing of changing, when the process executes the fourth specific instruction, the attribute value of the process to an attribute value as of before change.

The first effect is to prevent unexpected processing of a signal handler from hindering normal execution of a process.

The reason is that by a signal handler changing unit called up by a first specific instruction, a signal handler of a process is changed to a signal handler hook function and by a signal handler returning unit called up by a second specific instruction, the signal handler changed to the signal handler hook function is returned to a former state, so that only a signal handler executed during a period from the execution of the first specific instruction to the execution of the second specific instruction becomes a signal handler hook function, and a signal handler executed during the processing of this period will be executed as a signal handler yet to be changed to a signal handler hook function by the signal handler changing unit, with an attribute value of the process changed by a security level changing unit called up by a third specific instruction in the signal handler hook function and with such an instruction and an access to a resource as prevent normal execution of the process inhibited.

The second effect is that for the purpose of realizing the present invention, it is unnecessary to change processing to be executed in a period from when a signal is generated until when an OS executes a signal handler of a signal transmission destination.

The reason is that by the signal handler changing unit called up by the first specific instruction, a signal handler of a process is changed to a signal handler hook function and by the security level changing unit called up by the third specific instruction in the signal handler hook function, execution of a signal handler is detected to change an attribute value of the process.

### BRIEF DESCRIPTION OF THE DRAWINGS

FIG. 1 is a block diagram showing an example of a hardware structure of an information processing device according to the present invention;

FIG. 2 is a block diagram of a first mode of implementation of the present invention;

FIG. 3 is a flow chart showing an example of processing of a signal handler changing unit in the first mode of implementation of the present invention;

FIG. 4 is a flow chart showing an example of processing of a signal handler obtaining unit in the first mode of implementation of the present invention;

FIG. 5 is a flow chart showing an example of processing of a security level changing unit in the first mode of implementation of the present invention;

FIG. 6 is a flow chart showing an example of processing of a security level returning unit in the first mode of implementation of the present invention;

FIG. 7 is a flow chart showing an example of processing of a signal handler returning unit in the first mode of implementation of the present invention;

FIG. 8 is a block diagram of a second mode of implementation of the present invention;

FIG. 9 is a flow chart showing an example of processing of a security level changing unit in the second mode of implementation of the present invention;

FIG. 10 is a block diagram of a third mode of implementation of the present invention;

FIG. 11 is a flow chart showing an example of processing of a signal handler obtaining unit in the third mode of implementation of the present invention;

FIG. 12 is a flow chart showing an example of processing of a security level changing unit in the third mode of implementation of the present invention;

FIG. 13 is a block diagram of a fourth mode of implementation of the present invention;

FIG. 14 is a flow chart showing an example of processing of a signal handler changing unit in the fourth mode of implementation of the present invention;

FIG. 15 is a flow chart showing an example of processing of the signal handler changing unit in the fourth mode of implementation of the present invention;

FIG. 16 is a flow chart showing an example of processing of the signal handler changing unit in the fourth mode of implementation of the present invention;

FIG. 17 is a flow chart showing an example of processing of a signal handler obtaining unit in the fourth mode of implementation of the present invention;

FIG. 18 is a flow chart showing an example of processing of a signal handler returning unit in the fourth mode of implementation of the present invention;

FIG. 19 is a flow chart showing an example of processing of the signal handler returning unit in the fourth mode of implementation of the present invention;

FIG. 20 is a flow chart showing an example of processing of the signal handler returning unit in the fourth mode of implementation of the present invention;

FIG. 21 is a block diagram of a first exemplary embodiment of the present invention;

FIG. 22 is a diagram for use in explaining a signal handler table and a default signal handler table of the first exemplary embodiment of the present invention;

FIG. 23 is a block diagram of a second exemplary embodiment of the present invention;

FIG. 24 is a diagram for use in explaining a signal handler table and a default signal handler table of the second exemplary embodiment of the present invention;

FIG. 25 is a block diagram of a third exemplary embodiment of the present invention;

FIG. 26 is a diagram for use in explaining a signal handler table and a default signal handler table of the third exemplary embodiment of the present invention;

FIG. 27 is a block diagram of a fourth exemplary embodiment of the present invention;

FIG. 28 is a diagram for use in explaining a signal handler table of the fourth exemplary embodiment of the present invention;

FIG. 29 is a diagram for use in explaining a default signal handler table of the fourth exemplary embodiment of the present invention; and

FIG. 30 is a diagram showing an operation sequence of a process in the fourth exemplary embodiment of the present invention.

### EXEMPLARY EMBODIMENT

Next, best modes for implementing the present invention will be detailed with reference to the drawings.

### (Example of Hardware Structure of Information Processing Device According to the Present Invention)

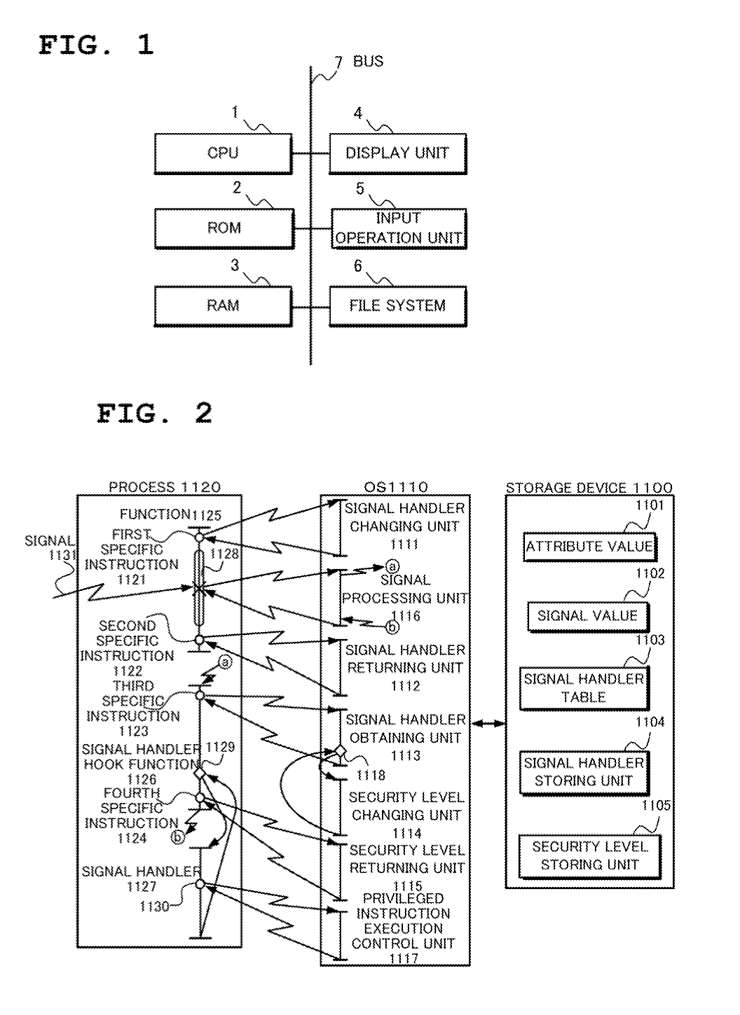

With reference to FIG. 1, one example of a hardware structure of an information processing device according to the present invention comprises a CPU 1, a ROM 2, a RAM 3, a display unit 4, an input operation unit 5, a file system 6 and a bus 7 which connects these components with each other. The ROM 2, which is a read only memory, stores an operating system (OS) to be executed by the CPU 1, a library function and fixed data. The RAM 3, which is a readable and writable memory, temporarily stores an application process to be executed by the CPU1 and variable data. The display unit 4, which is formed of an LCD or the like, displays an application screen or the like. The input operation unit 5, which is formed of a keyboard or the like, receives input of data or an instruction from a user. The file system 6, which is formed of a hard disk or an SD card, stores an application program or various kinds of data. Among examples of an information processing device having such a hardware structure are a common computer such as a personal computer, a game playing terminal and a cellular phone.

### First Mode of Implementation

With reference to FIG. 2, the first mode of implementation of the present invention includes a storage device 1100, an OS 1110 and a process 1120.

The storage device 1100 stores an attribute value 1101 indicative of a security level of the process 1120, a signal value 1102 and a signal handler table 1103. The device also has a signal handler storing unit 1104 as a saving region of the signal handler table 1103 and a security level storing unit 1105 as a saving region of the attribute value 1101.

The signal handler storing unit 1104 stores an identifier of a process and the signal handler table 1103 as a pair. For discriminating the signal handler table 1103 saved in the signal handler storing unit 1104 from the signal handler table 1103 yet to be saved, the former will be referred to as a default signal handler table.

The security level storing unit 1105 stores an identifier of a process and an attribute value of the process as a pair.

The process 1120 includes a function 1125, a signal handler hook function 1126 and a signal handler 1127.

The function 1125 of the process 1120, which is a highly reliable function whose alteration is impossible, has a part 1128 whose execution is guaranteed. The function 1125 also has a first specific instruction 1121 inserted at a part immediately before execution of the part 1128 whose execution is guaranteed and a second specific instruction 1122 inserted at a part immediately after execution of the part 1128 whose execution is guaranteed.

The signal handler hook function 1126 has a third specific instruction 1123 inserted at a part immediately after the start of its execution and a fourth specific instruction 1124 inserted at a part immediately before the end of the execution. Also inserted in a section between the third specific instruction 1123 and the fourth specific instruction 1124 is an instruction 1129 to execute the signal handler 1127 of an address obtained by the execution of the third specific instruction 1123.

The signal handler 1127 includes a privileged instruction 1130.

The OS 1110 is a secure OS capable of setting a security level on a process basis, for example.

The OS 1110 is a secure OS capable of setting a security level on a process basis, for example. The OS 1110 manages execution of the process 1120 and the attribute value 1101 of the process 1120. The attribute value 1101 is an attribute value for use in determining whether to allow a privileged instruction or an access to resource control that is executed by a process. Provided as an inter-process communication function is a function of managing a signal and when a signal 1131 to the process 1120 is generated, calling up a signal processing unit 1116. Further provided are a function of calling up a signal handler changing unit 1111 by the first specific instruction 1121, a function of calling up a signal handler returning unit 1112 by the second specific instruction 1122, a function of calling up a signal handler obtaining unit 1113 by the third specific instruction 1123, a function of calling up a security level returning unit 1115 by the fourth specific instruction 1124, and a function of calling up a privileged instruction execution control unit 1117 by the privileged instruction 1130. Also provided is a function of calling up a security level changing unit 1114 by an instruction 1118 inserted in the signal handler obtaining unit 1113.

The signal handler changing unit 1111, which is called up when the function 1125 of the process 1120 executes the first specific instruction 1121, has a function of saving an identifier of the process 1120 and the signal handler table 1103 in pair into the signal handler storing unit 1104 to change a signal handler set at the former signal handler table 1103 to the signal handler hook function 1126.

The signal processing unit 1116 has a function of referring to the signal handler table 1103 of the process 1120 in which the signal 1131 is generated to execute a function set corresponding to the generated signal 1131 (which is the signal handler 1127 or the signal handler hook function 1126). At the execution of a function, a value of the generated signal 1131 is given to the function.

The signal handler obtaining unit 1113, which is called up by the third specific instruction 1123 to be executed with a value of the received signal 1131 as an argument in the signal handler hook function 1126 executed upon reception of the signal 1131 by the process 1120, has a function of obtaining a signal handler corresponding to the signal 1131 from a default signal handler table to be paired with the identifier of the process 1120 in the signal handler storing unit 1104, calling up the security level changing unit 1114 by the instruction 1118 and after the processing of the security level changing unit 1114 is finished, giving the obtained signal handler to the signal handler hook function 1126.

The security level changing unit 1114, which is called up by the instruction 1118 in the signal handler obtaining unit 1113, has a function of, after saving the pair of the identifier and the attribute value 1101 of the process 1120 into the security level storing unit 1105, changing the former attribute value 1101 of the process 1120.

The security level returning unit 1115, which is called by the fourth specific instruction 1124 of the signal handler hook function, has a function of changing the attribute value 1101 of the process 1120 to an attribute value to be paired with the identifier of the process 1120 saved in the security level storing unit 1105 to delete the pair of the identifier and the attribute value of the process 1120 stored in the security level storing unit 1105.

The signal handler returning unit 1112, which is called up at the execution of the second specific instruction 1122 by the function 1125 of the process 1120, has a function of returning the signal handler hook function 1126 set as a signal handler at the signal handler table 1103 of the process 1120 to a signal handler set at a default signal handler table to be paired with the identifier of the process 1120 saved in the signal handler storing unit 1104 to delete the pair of the identifier of the process 1120 and the default signal handler table saved in the signal handler storing unit 1104.

The privileged instruction execution control unit 1117, which is called up when the process 1120 executes the privileged instruction 1130, has a function of controlling whether to execute the privileged instruction 1130 based on the attribute value 1101 of the process 1120.

Next, entire operation of the present mode of implementation will be detailed.

When the process 1120 calls up the function 1125, the first specific instruction 1121 disposed in the function 1125 is executed to call up the signal handler changing unit 1111.

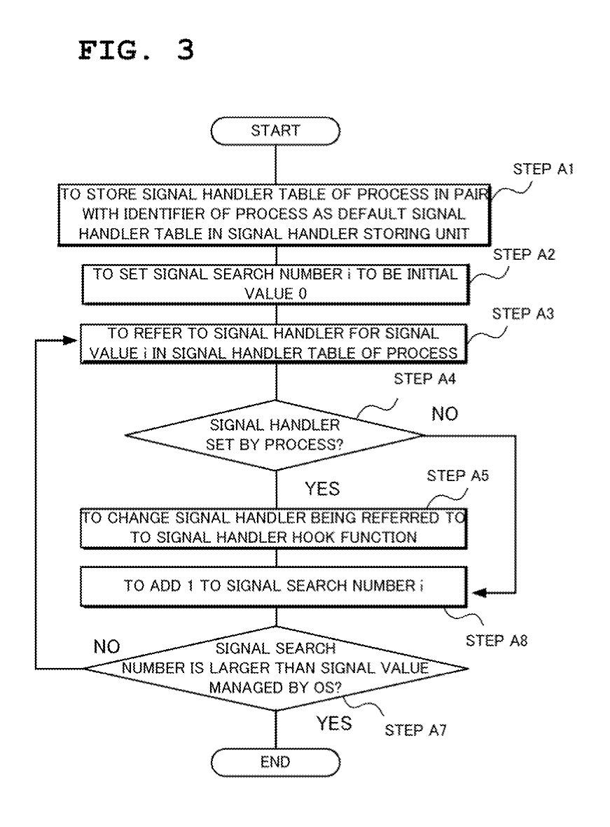

With reference to FIG. 3, the signal handler changing unit 1111 first stores (saves) the signal handler table 1103 in pair with the identifier of the process 1120 as a default signal handler table into the signal handler storing unit 1104 (Step A1). Next, the signal handler changing unit 1111 sets the signal search number i to be the initial value 0 (Step A2). Next, with reference to a signal handler set corresponding to a signal whose signal value is i in the signal handler table 1103 of the process 1120 (Step A3), when the signal handler is a signal handler set by the process 1120 (YES in Step A4), set the signal handler hook function 1126 as a signal handler corresponding to the signal whose signal value is i (Step A5). Then, add 1 to the signal search number (Step A6). When no signal handler of the process 1120 is set corresponding to the signal whose signal value is i (No at Step A4), skip Step A5 to add 1 to the signal search number i (Step A6).

Next, when the signal search number i as of after update is a value larger than a maximum value S of the signal number managed by the OS 1110 (YES at Step A7), the signal handler changing unit 1111 ends the signal handler changing processing. As a result, the execution of the first specific instruction 1121 ends to resume the processing of the function 1125 of the process 1120. On the other hand, when the signal search number i as of after update is a value equal to or smaller than S (NO at Step A7), return to Step A3 to repeat the same processing as the above-described processing.

Next, assume that after the execution of the first specific instruction 1121 is finished, the process 1120 executing the function 1125 receives the signal 1131. Then, the execution of the function 1125 is interrupted by the OS 1110 to execute the signal processing unit 1116. The signal processing unit 1116 takes out a signal handler corresponding to a value of the signal 1131 from the signal handler table 1103 of the process 1120 and shifts control to the same. In this case, since the signal handler hook function 1126 is registered corresponding to the signal 1131 in the signal handler table 1103 of the process 1120, the signal handler hook function 1126 will be executed. At this time, the value of the signal 1131 will be given from the signal processing unit 1116 to the signal handler hook function 1126.

With the received value of the signal 1131 as an argument, the signal handler hook function 1126 executes the third specific instruction 1123. By the execution of the third specific instruction 1123, the signal handler obtaining unit 1113 is called up.

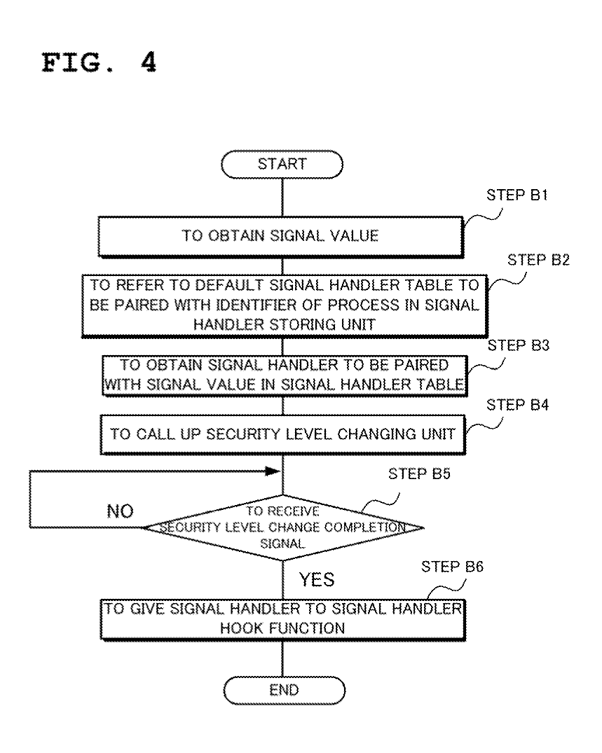

With reference to FIG. 4, the signal handler obtaining unit 1113 obtains the value of the signal 1131 which is an argument of the third specific instruction 1123 (Step B1). Next, with reference to the signal handler storing unit 1104, refer to a default signal handler table to be paired with the identifier of its own process 1120 (Step B2) to obtain the signal handler 1127 set corresponding to the value of the signal 1131 (Step B3). Next, by the execution of the instruction 1118, notify the identifier of the process 1120 to call up the security level changing unit 1114 (Step B4) and wait for reception of a security level change completion signal from the security level changing unit 1114 (Step B5).

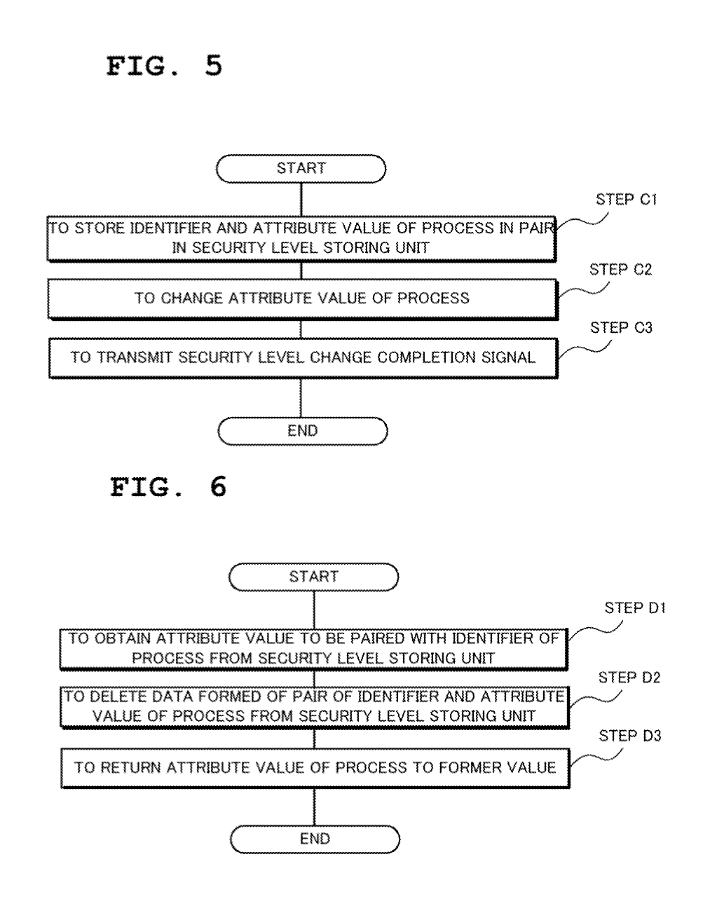

With reference to FIG. 5, when called up by the signal handler obtaining unit 1113, the security level changing unit 1114 stores (saves) a pair of the identifier of the process 1120 and its attribute value 1101 in the security level storing unit 1105 (Step C1). Next, change the attribute value 1101 of the process 1120 (Step C2) and transmit the security level change completion signal to the signal handler obtaining unit 1113 (Step C3) to end the processing. Here, the value of the attribute value 1101 of the process 1120 as of before a change will be denoted as Nx and that as of after the change as Ny. Ny as of after a change is assumed to represent a security level which allows no privileged instruction to be executed.

Upon receiving the security level change completion signal, the signal handler obtaining unit 1113 gives the signal handler 1127 obtained from the signal handler storing unit 1104 at Step B3 to the signal handler hook function 1126 (Step B6) to end the processing.

The signal handler hook function 1126 executes the signal handler 1127 obtained from the signal handler obtaining unit 1113 through the third specific instruction 1123. When the privileged instruction 1130 inserted in the signal handler 1127 is executed during the execution of the signal handler 1127, the control shifts to the privileged instruction execution control unit 1117. The privileged instruction execution control unit 1117 refers to the attribute value 1101 of the process 1120 having executed the privileged instruction 1130 to determine whether the process has a security level enabling execution of a privileged instruction. In this case, since the attribute value 1101 is changed to the value Ny not allowing execution of the privileged instruction, the privileged instruction 1130 will not be executed. On the other hand, under a condition where the attribute value 1101 is Nx, the privileged instruction 1130 will be executed.

When the execution of the signal handler 1127 ends, the signal handler hook function 1126 will execute the fourth specific instruction 1124. When the fourth specific instruction 1124 is executed, the security level returning unit 1115 will be called up with the identifier of the process 1120.

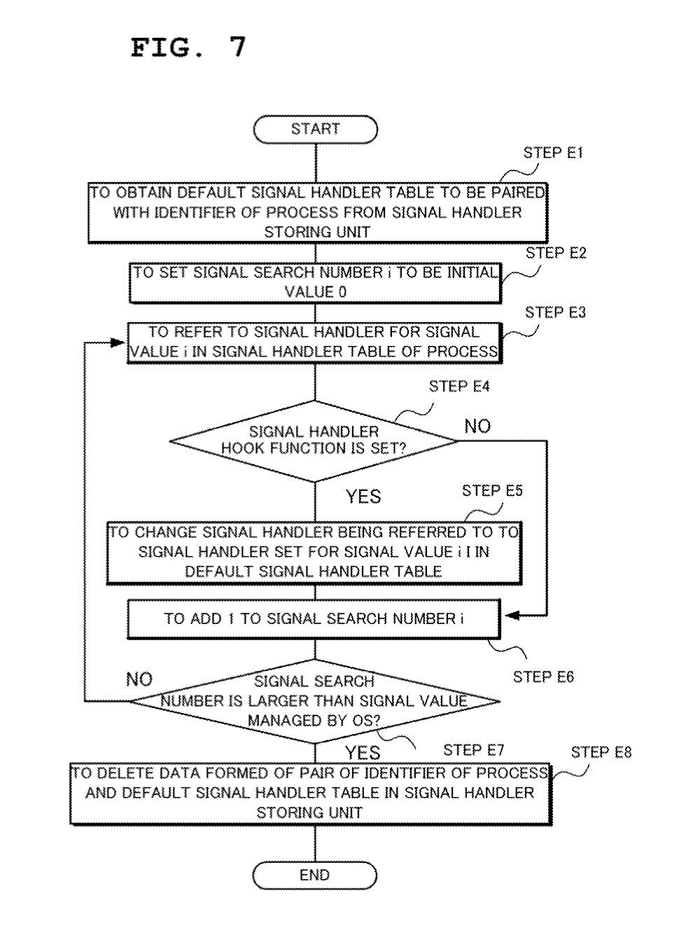

With reference to FIG. 6, the security level returning unit 1115 refers to the security level storing unit 1105 to obtain the attribute value Nx to be paired with the identifier of the process 1120 (Step D1). Next, delete the data formed of a pair of the identifier and the attribute value Nx of the process 1120 stored in the security level storing unit 1105 (Step D2). Then, change the attribute value 1101 of the process 1120 from Ny to Nx (Step D3). This completes the processing of the security level returning unit 1115 to return the control to the signal handler hook function 1126, thereby completing the execution of the fourth specific instruction 1124. When the execution of the fourth specific instruction 1124 ends, the processing of the signal handler hook function 1126 is finished. When the processing of the signal handler hook function 1126 ends, the control is returned to the function 1125 through the signal processing unit 1116 to resume the processing of the function 1125.

When the processing of the function 1125 resumes to execute the second specific instruction 1122 arranged in the function 1125, the signal handler returning unit 1112 is called up with the identifier of the process 1120.

With reference to FIG. 7, the signal handler returning unit 1112 refers to the signal handler storing unit 1104 to obtain a default signal handler table to be paired with the identifier of the process 1120 (Step E1). Next, the signal handler returning unit 1112 sets the signal search number i to be the initial value 0 (Step E2). Next, refer to a signal handler set corresponding to the value i of the signal in the signal handler table 1103 of the process 1120 (Step E3). When the referred signal handler is a signal handler hook function (YES at Step E4), set a signal handler registered in the default signal handler table corresponding to the signal value i as a signal handler of the process 1120 (Step E5). At the end of the signal handler setting or when the referred signal handler has no signal handler hook function set (NO at Step E4), add 1 to the signal search number i (Step E6). When the signal search number i is a value larger than the maximum value S (YES at Step E7), delete data formed of a pair of the identifier of the process 1120 and a default signal handler table stored in the signal handler storing unit 1104 (Step E8). Then, end the execution of the second specific instruction 1122 to continue the processing of the function 1125. When the signal, search number i is a value equal to or smaller than S (NO at Step E7), return to Step E3 to repeat the same processing as that described above.

Next, an effect of the present mode of implementation will be described.

The present mode of implantation enables, even among the same signal handlers 1127, a signal handler 1127 to be executed by a signal received while the process 1120 executes a′specific processing section and other signal handlers 1127 to be logically discriminated from each other to execute the former signal handler 1127 with a security level of the process 1120 changed. The reason is that while the process 1120 executes a specific processing section, by changing a signal handler to a signal handler hook function, execution of the former signal handler is detected to execute the signal handler with a security level changed.

### Second Mode of Implementation

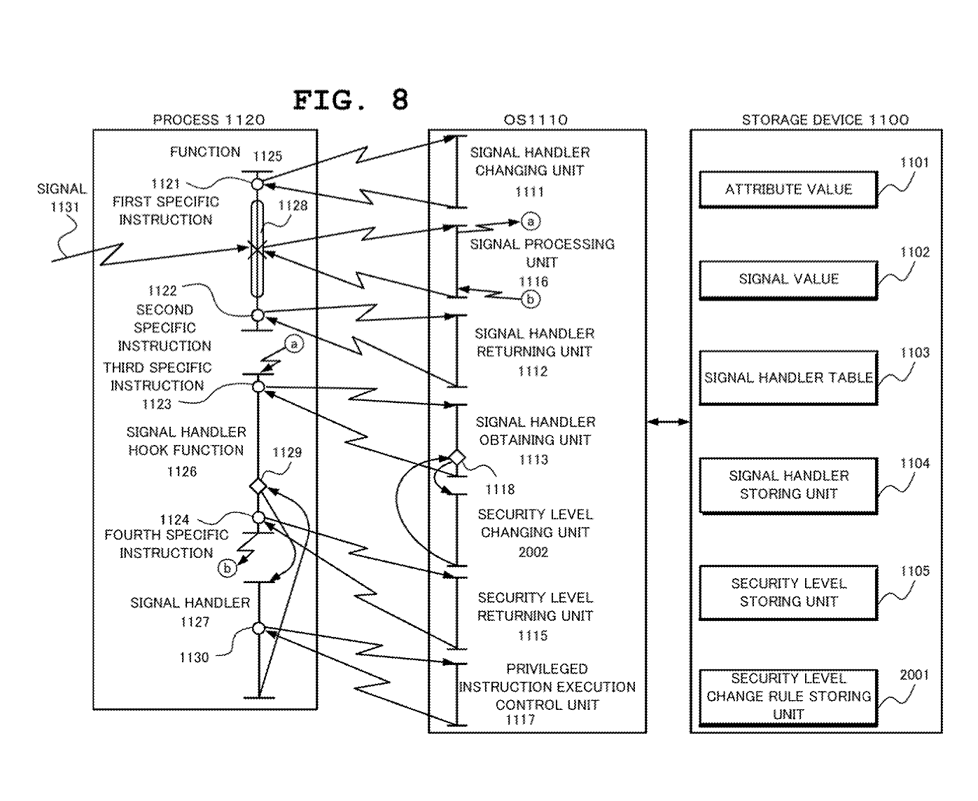

With reference to FIG. 8, a second mode of implementation of the present invention differs from the first mode of implementation shown in FIG. 2 in that the storage device 1100 has a security level change rule storing unit 2001 and the OS 1110 has a security level changing unit 2002 in place of the security level changing unit 1114.

The security level change rule storing unit 2001 stores a change rule including a pair of an attribute value of the process 1120 as of before a change and an attribute value as of after a change in advance. Here, the attribute value 1101 of the process 1120 as of before a change is denoted as Nx and an attribute value as of after a change as Nxx.

The security level changing unit 2002 is called up by the signal handler obtaining unit 1113 to obtain an identifier of the process 1120 and the attribute value 1101 and store (save) the same as a pair in the security level storing unit 1105 and thereafter, refers to the security level change rule storing unit 2001 to obtain an attribute value Nxx as of after a change which is to be paired with the attribute value 1101 as of before a change and change the attribute value 1101 of the process 1120 to the obtained attribute value Nxx.

Next, entire operation of the present mode of implementation will be described. Since among the operations of the present mode of implementation, operation different from that of the first mode of implementation is only the operation of the security level changing unit 2002, description will be made of the operation of the security level changing unit 2002 in the following.

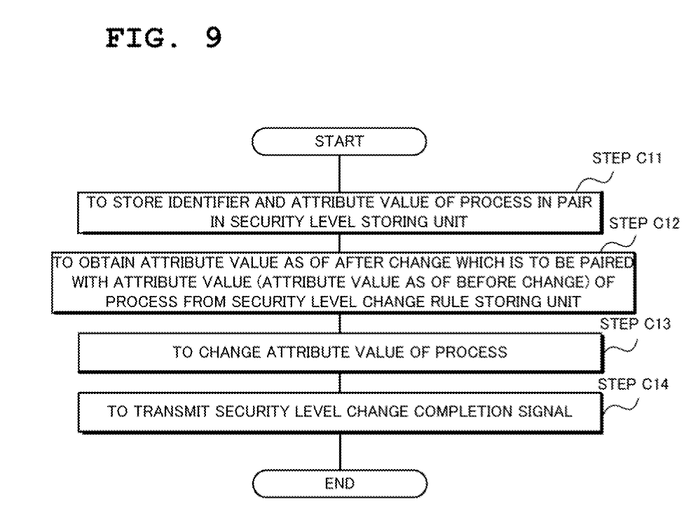

With reference to FIG. 9, when called up by the signal handler obtaining unit 1113, the security level changing unit 2002 stores (saves) a pair of the identifier of the process 1120 and its attribute value 1101 in the security level storing unit 1105 (Step C11). Next, refer to the security level change rule storing unit 2002 to obtain an attribute value Nxx as of after a change which is to be paired with the attribute value 1101 (=Nx) as of before a change (Step C12) and change the attribute value 1101 of the process 1120 to the obtained attribute value Nxx (Step C13). Then, transmit a security level change completion signal to the signal handler obtaining unit 1113 (Step C14).

Next, an effect of the present mode of implementation will be described.

The present mode of implementation has an effect, in addition to the effect of the first mode of implementation, that according to a security level of the process 1120, a security level of the process at the execution of a signal handler can be changed based on the security level change rules stored in advance.

### Third Mode of Implementation

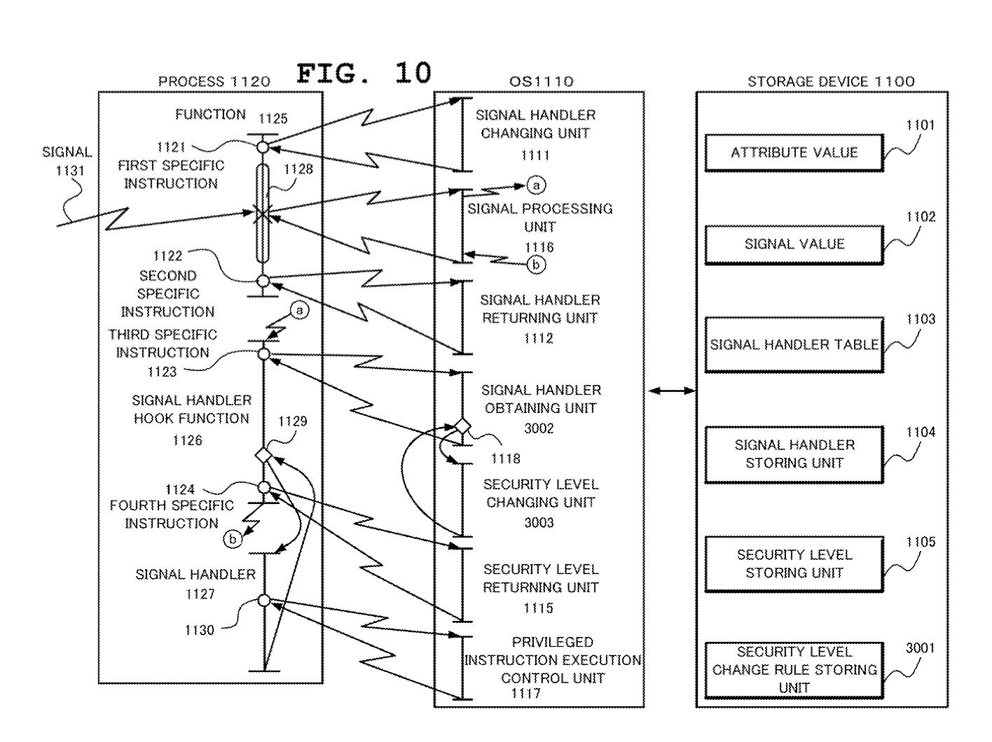

With reference to FIG. 10, a third mode of implementation of the present invention differs from the first mode of implementation shown in FIG. 2 in that the storage device 1100 has a security level change rule storing unit 3001, and the OS 1110 has a signal handler obtaining unit 3002 and a security level changing unit 3003 in place of the signal handler obtaining unit 1113 and the security level changing unit 1114.

The security level change rule storing unit 3001 stores a change rule in advance which includes a pair of a value of the signal 1131 received by the process 1120 and an attribute value of the process 1120. Here, denote the attribute value 1101 of the process 1120 as of before a change as Nx and an attribute value corresponding to a value of the signal 1131 as Nxx.

From the signal handler hook function 1126 executed upon reception of the signal 1131 by the process 1120, the signal handler obtaining unit 3002 is called up by the third specific instruction 1123 to be executed with the value of the received signal 1131 as an argument to refer to the signal handler storing unit 1104 and after obtaining the signal handler 1127 corresponding to the value of the signal 1131 from a signal handler table which is to be paired with the identifier of the process 1120, calls up the security level changing unit 3003 and transfers the value of the signal 1131 to the unit and after the end of the processing of the security level changing unit 3003, gives the obtained signal handler 1127 to the signal handler hook function 1126.

When called by the signal handler obtaining unit 3002 to receive the value of the signal 1131, after storing (saving) a pair of the identifier of the process 1120 and the attribute value 1101 in the security level storing unit 1105, the security level changing unit 3003 refers to the security level change rule storing unit 3001 to obtain an attribute value Nxx to be paired with the value of the signal 1131 and change the attribute value 1101 of the process 1120 to the attribute value Nxx.

Next, entire operation of the present mode of implementation will be described. Since among operations of the present mode of implementation, operation different from that of the first mode of implementation is only the operation of the signal handler obtaining unit 3002 and the security level changing unit 3003, description will be made in the following of the operations of the signal handler obtaining unit 3002 and the security level changing unit 3003.

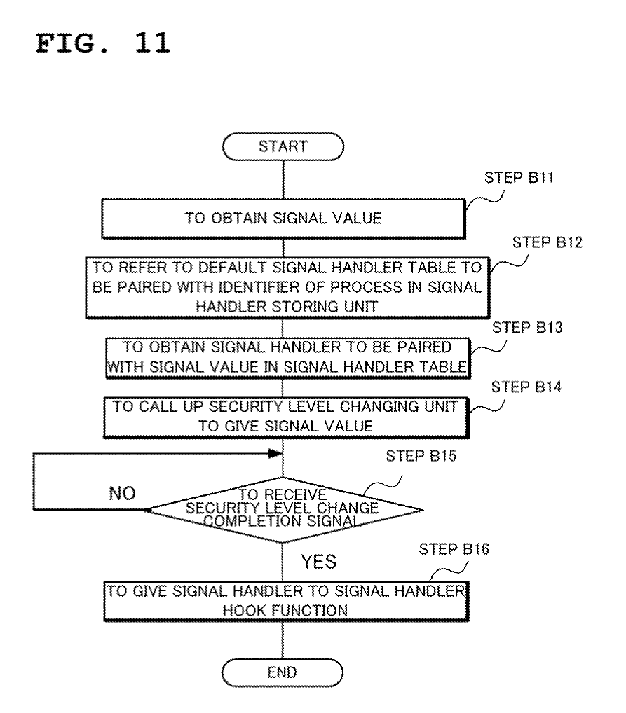

With reference to FIG. 11, when called up from the signal handler hook function 1126 by the third specific instruction 1123 with the value of the signal 1131 as an argument, the signal handler obtaining unit 3002 obtains the value of the signal 1131 (Step B11). Next, with reference to the signal handler storing unit 1104 to refer to a default signal handler table to be paired with the identifier of the process 1120 (Step B12), obtain the signal handler 1127 set corresponding to the value of the signal 1131 (Step B13). Next, by executing the instruction 1118, notify the identifier of the process 1120 and the value of the signal 1131 to call up the security level changing unit 3003 (Step B14) and wait for reception of a security level change completion signal from the security level changing unit 3003 (Step B15).

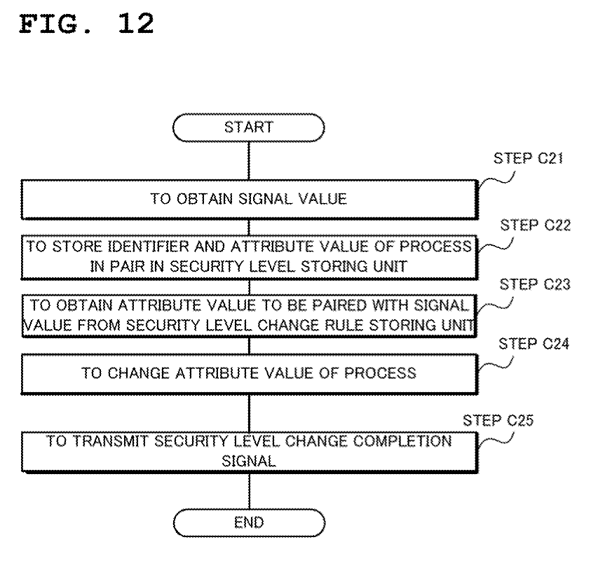

With reference to FIG. 12, when called by the signal handler obtaining unit 3002, the security level changing unit 3003 obtains the value of the signal 1131 (Step C21) to store (save) a pair of the identifier of the process 1120 and its attribute value 1101 in the security level storing unit 1105 (Step C22). Next, store (save) a pair of the identifier and the attribute value 1101 of the process 1120 in the security level storing unit 1105 (Step C22). Next, with reference to the security level change rule storing unit 3001, obtain an attribute value Nxx to be paired with the value of the signal 1131 obtained from the signal handler obtaining unit 3002 (Step C23) and change the attribute value 1101 of the process 1131 to the obtained attribute value Nxx (Step C24). Then, transmit a security level change completion signal to the signal handler obtaining unit 3002 (Step 025).

Upon receiving the security level change completion signal, the signal handler obtaining unit 3002 gives the signal handler 1127 obtained from the signal handler storing unit 1104 at Step B13 to the signal handler hook function 1126 (Step B16) to end the processing.

Next, an effect of the present mode of implementation will be described.

The present mode of implementation enables, in addition to the effect of the first mode of implementation, a security level of a process at the execution of a signal handler to be changed according to a value of the generated signal 1131 based on security level change rules stored in advance.

### Fourth Mode of Implementation

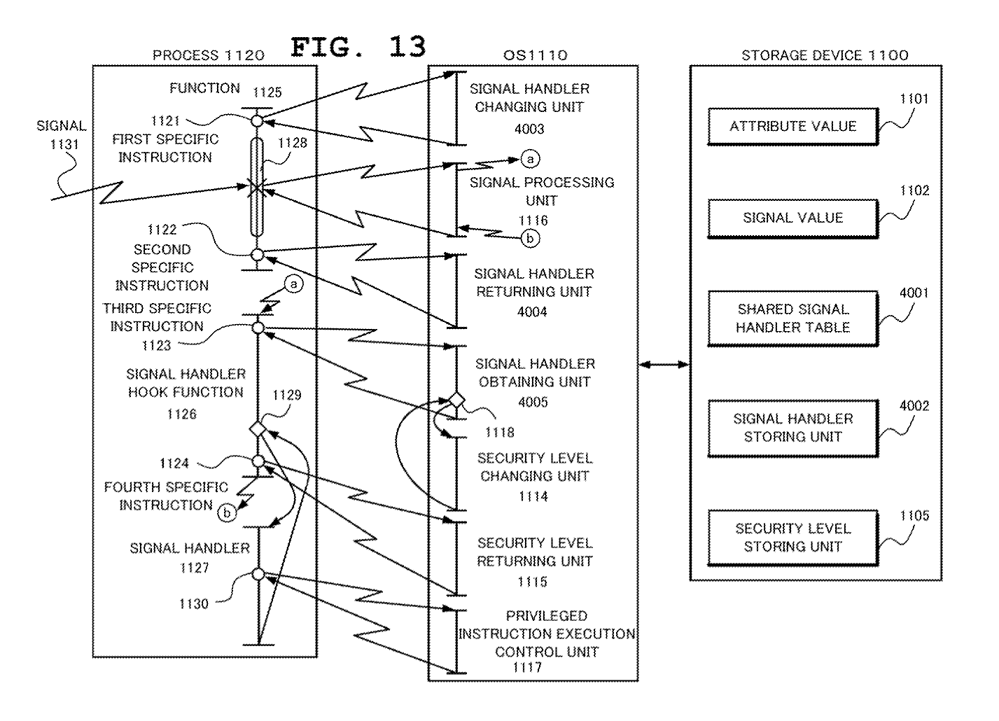

With reference to FIG. 13, a fourth mode of implementation of the present invention differs from the first mode of implementation shown in FIG. 2 in that the storage device 1100 has a shared signal handler table 4001 and a signal handler storing unit 4002 in place of the signal handler table 1103 and the signal handler storing unit 1104, the OS 1110 has a signal handler changing unit 4003, a signal handler returning unit 4004 and a signal handler obtaining unit 4005 in place of the signal handler changing unit 1111, the signal handler returning unit 1112 and the signal handler obtaining unit 1113.

The shared signal handler table 4001 is a signal handler table shared by a plurality of processes 1120. In a case of the present mode of implementation, the OS 1110 manages a process which shares a signal handler table.

The signal handler storing unit 4002 is a storage unit for saving the shared signal handler table 4001. While the signal handler storing unit 1104 according to the first mode of implementation stores a pair of an identifier of one process 1120 and a signal handler table, the signal handler storing unit 4002 according to the present mode of implementation stores a group of process identifiers and the shared signal handler table 4001 in pair. Here, a process identifier group is a set of at least one process identifier of a process which shares the shared signal handler table 4001 to be paired.

Upon called up at the execution of the first specific instruction 1121 by the function 1125 of the process 1120, the signal handler changing unit 4003, when there exists other process that shares the shared signal handler table 4001 with the own process 1120 and an identifier of other process in question is stored in the process identifier group of the signal handler storing unit 4002, adds the process identifier of the own process 1120 to the process identifier group to store (save), in the default signal handler table to be paired with the process identifier group, other signal handler than the signal handler hook function 1126 set at the shared signal handler table 4001 of the own process 1120. Then, change the signal handler set at the shared signal handler table 4001 of the own process 1120 to the signal handler hook function 1126.

On the other hand, in a case where there exists no other process that shares the shared signal handler table 4001 with the own process 1120 or in a case where, even if there exists such other process, an identifier of other process is not stored in the process identifier group of the signal handler storing unit 4002, the signal handler changing unit 4003 stores (saves), in the signal handler storing unit 4002, the identifier of the process 1120 as a process identifier group and the shared signal handler table 4001 as a default signal handler table to change a signal handler set at the shared signal handler table 4001 of the process 1120 to the signal handler hook function 1126.

When called at the execution of the second specific instruction 1122 by the function 1125 of the process 1120, the signal handler returning unit 4004 refers to a process identifier group in the signal handler storing unit 4002 including the process identifier of the process 1120 and when there exists other process identifier than that of the process 1120, stores (saves), in a default signal handler table to be paired with the process identifier group, a signal handler other than the signal handler hook function 1126 set at the shared signal handler table 4001 of the process 1120. Then, delete the identifier of the process 1120 from the process identifier group.

On the other hand, when there exists no other process identifier than the identifier of the process 1120 in the process identifier group, the signal handler returning unit 4004 changes the signal handler hook function 1126 set as a signal handler at the shared signal handler table 4001 of the process 1120 to a signal handler set at a default signal handler table stored in pair with the process identifier group including the identifier of the process 1120 in the signal handler storing unit 4002. Then, delete data formed of a pair of the process identifier group including the identifier of the process 1120 and the default signal handler table stored in the signal handler storing unit 4002.

The signal handler obtaining unit 4005 is a unit approximately the same as the signal handler obtaining unit 1113. More specifically, the signal handler obtaining unit 4005, which is called up, in the signal handler hook function 1126 executed upon reception of the signal 1131 by the process 1120, by the third specific instruction 1123 to be executed with the value of the received signal 1131 as an argument, has a function of obtaining a signal handler corresponding to the signal 1131 from a default signal handler table to be paired with the process identifier group including the identifier of the process 1120 in the signal handler storing unit 4002 and calling up the security level changing unit 1114 by the instruction 1118, and after the processing of the security level changing unit 1114 ends, giving the obtained signal handler to the signal handler hook function 1126.

Next, entire operation of the present mode of implementation will be described. Since among the operations of the present mode of implementation, operations different from those of the first mode of implementation are those of the signal handler changing unit 4003, the signal handler returning unit 4004 and the signal handler obtaining unit 4005, description will be made in the following of the operations of the signal handler changing unit 4003, the signal handler returning unit 4004 and the signal handler obtaining unit 4005.

When the process 1120 calls up the function 1125 to execute the first specific instruction 1121 arranged in the function 1125, the signal handler changing unit 4003 will be called up.

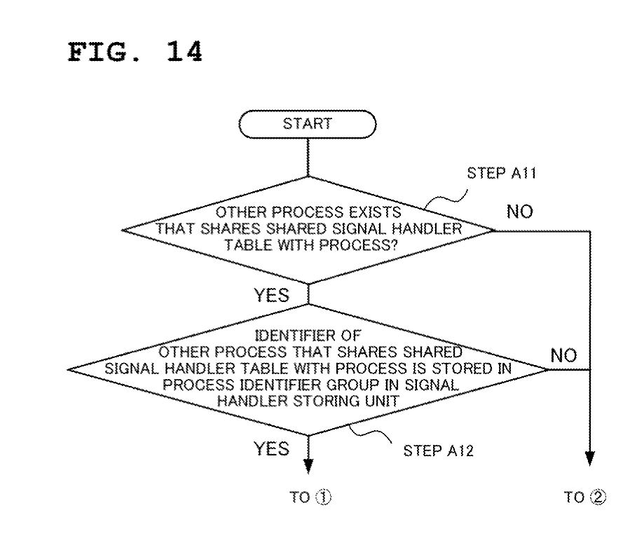

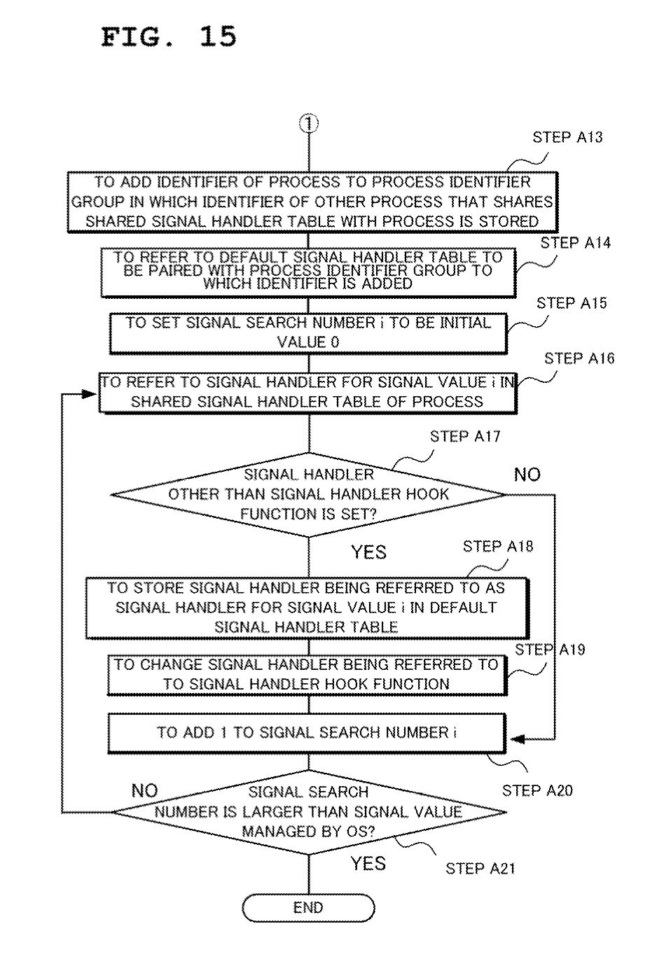

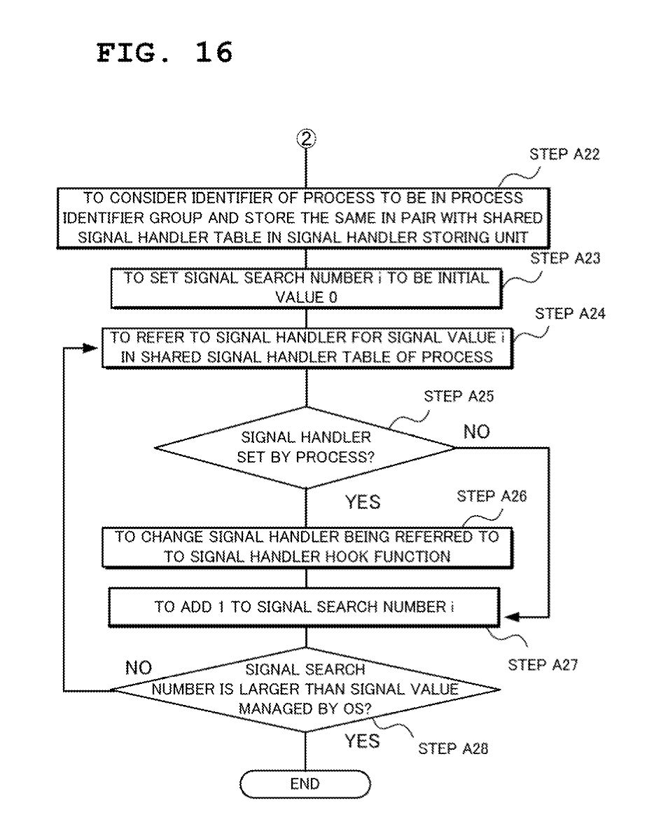

With reference to FIG. 14 through FIG. 16, when there exists other process that shares the shared signal handler table 4001 with the process 1120 (YES at Step A11), the signal handler changing unit 4003 determines whether an identifier of other process in question is stored in the process identifier group in the signal handler storing unit 4002 (Step A12). When the identifier of other process that shares the shared signal handler table 4001 with the process 1120 is stored in the process identifier group in the signal handler storing unit 4002 (YES at Step A12), add the process identifier of the process 1120 to the process identifier group (Step A13).

Next, the signal handler changing unit 4003 refers to a default signal handler table to be paired with the process identifier group (Step A14). Next, set the signal search number i to be the initial value 0 (Step A15). Next, refer to a signal handler set corresponding to the signal value i in the shared signal handler table 4001 of the process 1120 (Step A16) and when the referred signal handler has other signal handler set than the signal handler hook function 1126 (YES at Step A17), store (save) the signal handler as a signal handler corresponding to the signal value i in the default signal handler table (Step A18) to set the signal handler hook function 1126 as a signal handler corresponding to the signal value i in the shared signal handler table 4001 of the process 1120 (Step A19). Then, add 1 to the signal search number i (Step A20). On the other hand, when the referred signal handler fails to have other signal handler set than the signal handler hook function 1126 (NO at Step A17), skip Steps A18 and A19 to add 1 to the signal search number i (Step A20).

Next, when the signal search number i is larger than the maximum value S of the number of signals (YES at Step A21), the signal handler changing unit 4003 ends the processing. This completes the execution of the first specific instruction 1121 to resume the processing of the function 1125. On the other hand, when the signal search number i is equal to or smaller than S (NO at Step A21), return to Step A16 to repeat the same processing as the above-described processing.

When there exists no other process that shares the shared signal handler table with the process 1120 (NO at Step A11), or even if it exists, when an identifier of other process in question is not stored in the process identifier group of the signal handler storing unit 4002 (NO at Step A12), the signal handler changing unit 4003 stores (saves) the process identifier group including the identifier of the process 1120 and the shared signal handler table 4001 in pair in the signal handler storing unit 4002 (Step A22).

Next, the signal handler changing unit 4003 sets the signal search number i to be the initial value 0 (Step A23). Next, refer to the signal handler set corresponding to the signal value i in the shared signal handler table 4001 of the process 1120 (Step A24) and when the referred signal handler is a signal handler set by the process 1120 (YES at Step A25), change the signal handler to the signal handler hook function 1126 as a signal handler corresponding to the signal value i (Step A26). Then, add 1 to the signal search number i (Step A27). When the referred signal handler is not a signal handler set by the process 1120 (NO at Step A25), skip Step A26 to add 1 to the signal search number i (Step A27).

Next, when the signal search number i is larger than S (YES at Step A28), the signal handler changing unit 4003 ends the processing. This completes the execution of the first specific instruction 1121 to resume the processing of the function 1125. On the other hand, when the signal search number i is a value equal to or smaller than S (NO at Step A28); return to Step A24 to repeat the same processing as the above-described processing.

Assume here that after the process 1120 executing the function 1125 ends the execution of the first specific instruction 1121, the signal handler hook function 1126 receives the signal 1131 set as a signal handler. Then, the execution of the function 1125 is interrupted by the OS 1110 to execute the signal handler hook function 1126 through the signal processing unit 1116. Then, in the signal handler hook function 1126, the third specific instruction 1123 is executed with the value of the received signal 1131 as an argument, thereby calling up the signal handler obtaining unit 4005.

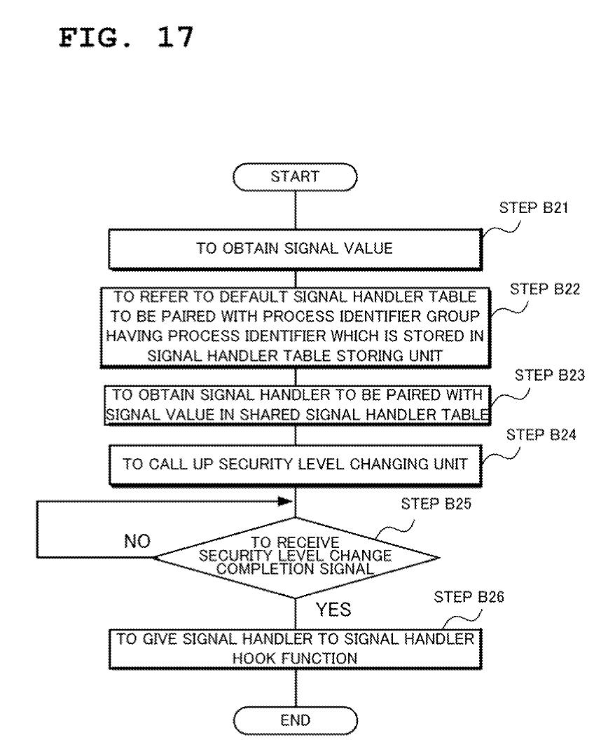

With reference to FIG. 17, the signal handler obtaining unit 4005 obtains the value of the signal 1131 which is an argument of the third specific instruction 1123 (Step B21). Next, refer to a default signal handler table to be paired with a process identifier group including the identifier of the own process 1120 in the signal handler storing unit 4002 (Step B22) to obtain the signal handler 1127 set corresponding to the value of the signal 1131 (Step B23). Next, by the execution of the instruction 1118, notify the identifier of the process 1120 to call up the security level changing unit 1114 (Step B24) and wait for reception of the security level change completion signal from the security level changing unit 1114 (Step B25).

As described with reference to FIG. 5, when called up by the signal handler obtaining unit 4005, the security level changing unit 1114 stores (saves) the pair of the identifier of the process 1120 and its attribute value 1101 in the security level storing unit 1105 (Step C1), changes the attribute value 1101 of the process 1120 (Step C2) and transmits the security level change completion signal to the signal handler obtaining unit 4005 (Step C3) to end the processing. Here, as a modification example of the present mode of implementation, the security level changing unit 1114 may check whether any of process identifier groups in the signal handler storing unit 4002 includes the identifier of the process 1120 and only when it is included (that is, a state where the process in question executes the first specific instruction 1121 of the function 1125 and not the second specific instruction 1122), change the attribute value 1101 of the process 1120.

When receiving the security level change completion signal, the signal handler obtaining unit 4005 gives the signal handler 1127 obtained from the signal handler storing unit 4002 at Step B23 to the signal handler hook function 1126 (Step B26) to end the processing.

The signal handler hook function 1126 executes the signal handler 1127 obtained from the signal handler obtaining unit 4005 through the third specific instruction 1123. When the privileged instruction 1130 inserted in the signal handler 1127 is executed during the execution of the signal handler 1127, control shifts to the privileged instruction execution control unit 1117. The privileged instruction execution control unit 1117 refers to the attribute value 1101 of the process 1120 having executed the privileged instruction 1130 to determine whether it is a security level enabling execution of the privileged instruction or not.

When the execution of the signal handler 1127 ends, the signal handler hook function 1126 executes the fourth specific instruction 1124. When the fourth specific instruction 1124 is executed, the security level returning unit 1115 is called up with the identifier of the process 1120.

As is already described with reference to FIG. 6, the security level returning unit 1115 refers to the security level storing unit 1105 to obtain an attribute value to be paired with the identifier of the process 1120 (Step D1).

Next, delete data formed of a pair of the identifier and the attribute value of the process 1120 stored in the security level storing unit 1105 (Step D2). Then, return the attribute value 1101 of the process 1120 to the former attribute value (Step D3).

Here, as a modification example of the present mode of implementation, the security level changing unit 1114 may check whether the identifier of the process 1120 is included in any of process identifier groups in the signal handler storing unit 4002 and when it is not included, end the processing without executing the processing of returning the attribute value 1101 of the process 1120 to the former value.

When the processing of the security level returning unit 1115 ends to return the control to the signal handler hook function 1126, the execution of the fourth specific instruction 1124 ends. When the execution of the fourth specific instruction 1124 ends, the processing of the signal handler hook function 1126 ends. When the processing of the signal handler hook function 1126 ends, the control is returned to the function 1125 through the signal processing unit 1116 to resume the processing of the function 1125. Then, when the processing of the function 1125 resumes to execute the second specific instruction 1122 arranged in the function 1125, the signal handler returning unit 4004 is called up with the identifier of the process 1120.

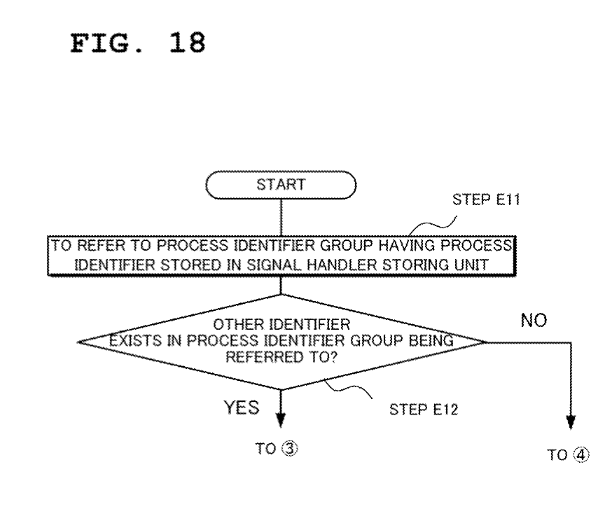

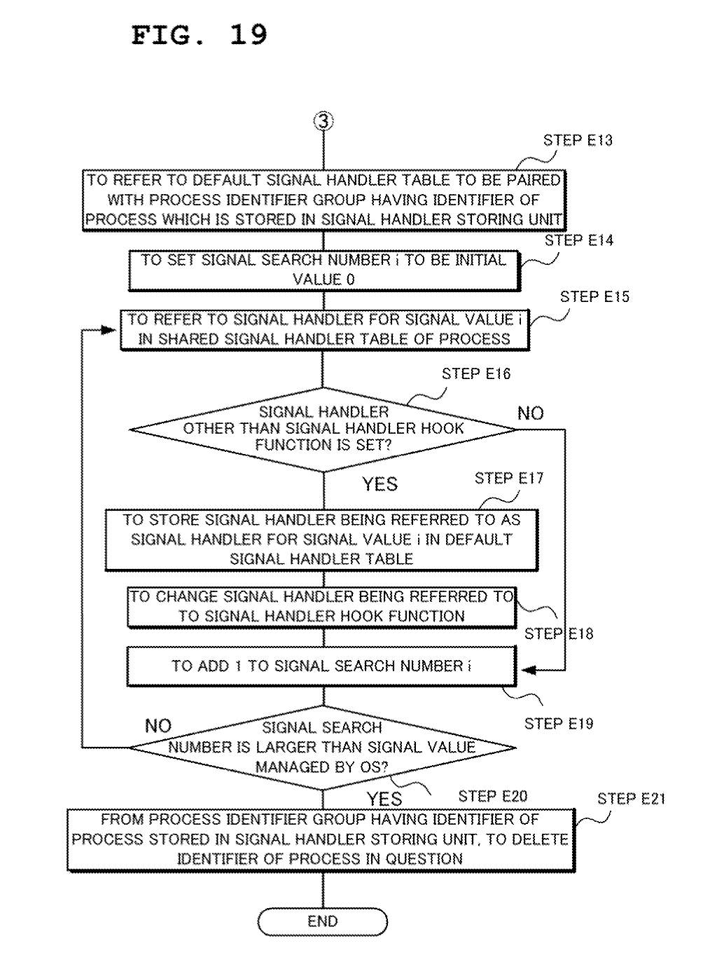

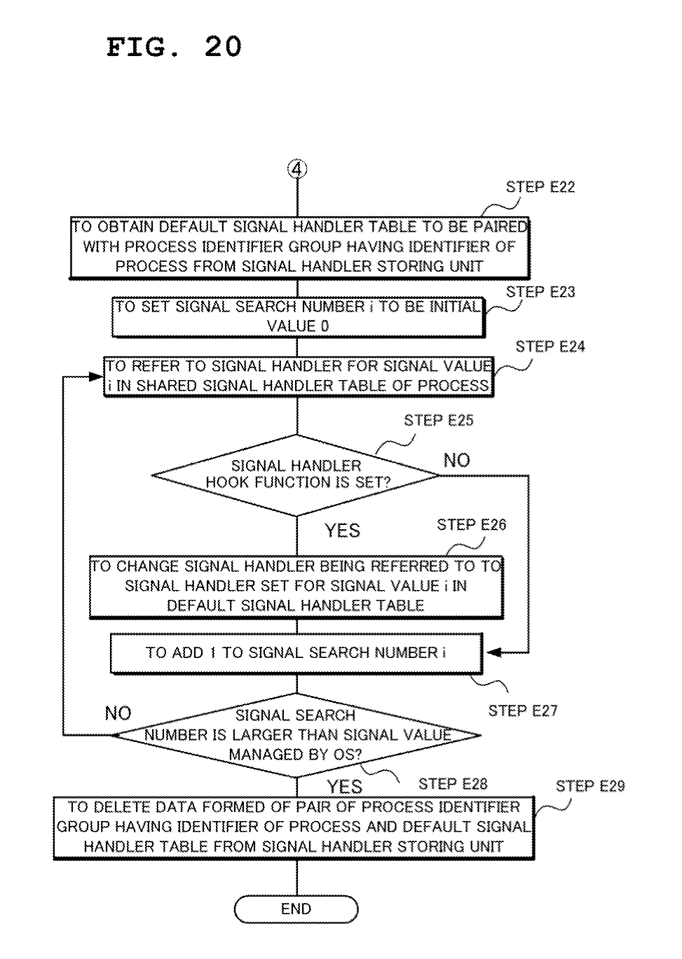

With reference to FIG. 18 through FIG. 20, the signal handler returning unit 4004 refers to a process identifier group including the process identifier of the process 1120 in the signal handler storing unit 4002 (Step E11) and when an identifier of other process than the process 1120 exists in the process identifier group (YES at Step E12), refers to a default signal handler table to be paired with the process identifier group (Step E13). Next, set the signal search number i to be the initial value 0 (Step S14) to refer to a signal handler corresponding to the signal value i in the shared signal handler table 4001 of the process 1120 (Step E15).

When the referred signal handler has other signal handler than the signal handler hook function 1126 set (YES at Step E16), the signal handler returning unit 4004 stores (saves) the signal handler in the signal handler storing unit 4002 as a signal handler corresponding to the signal value i in the default signal handler table (Step E17). Next, as a signal handler corresponding to the signal value i in the shared signal handler table 4001 of the process 1120 being referred to, set the signal handler hook function 1126 (Step E18). Then, add 1 to the signal search number i (Step E19). On the other hand, when the referred signal handler fails to have the signal handler hook function 1126 set (NO Step E16), skip the processing of Steps E17 and E18 to add 1 to the signal search number i (Step E19).

Next, when the signal search number i is a value larger than the maximum value S of the number of signals (YES at Step E20), the signal handler returning unit 4004 deletes the identifier of the process 1120 from the process identifier group stored in the signal handler storing unit 4002 (Step E21). Then, the signal handler returning unit 4004 ends the processing. This completes the execution of the second specific instruction 1122 to resume the processing of the function 1125. On the other hand, when the signal search number i is a value equal to or smaller than S (NO at Step E20), return to Step E15 to repeat the same processing as the above-described processing.

When an identifier of other process than the process 1120 fails to exist in the process identifier group (NO at Step E12), the signal handler returning unit 4004 obtains a default signal handler table to be paired with the process identifier group including the identifier of the process 1120 stored in the signal handler storing unit 4002 (Step E22). Next, the signal handler returning unit 4004 sets the signal search number i to be the initial value 0 (Step E23) to refer to a signal handler set corresponding to the signal value i in the shared signal handler table 4001 of the process 1120 (Step E24).

When the referred signal handler is the signal handler hook function 1126 (YES at Step S25), the signal handler returning unit 4004 reads a signal handler registered in the default signal handler table as a signal handler corresponding to the signal value i from the signal handler storing unit 4002 and sets the same as a signal handler corresponding to the signal value i in the shared signal handler table 4001 of the process 1120 (Step E26). Then, add 1 to the signal search number i (Step E27). On the other hand, when the referred signal handler is not the signal handler hook function 1126 (NO at Step E25), skip the processing of Step E26 to add 1 to the signal search number i (Step E27).

Next, when the signal search number i is a value larger than the maximum value S of the number of signals (YES at Step E28), the signal handler returning unit 4004 deletes data formed of a pair of the process identifier group including the identifier of the process 1120 and the default signal handler table stored in the signal handler storing unit 4002 (Step E29). Then, end the processing of the signal handler returning unit 4004. This completes the execution of the second specific instruction 1122 to resume the processing of the function 1125. On the other hand, when the signal search number i is a value equal to or smaller than S (NO at Step E28), return to Step E24 to repeat the same processing as the above-described processing.

Next, an effect of the present mode of implementation will be described.

At the time of changing a signal handler in a signal handler table, by executing processing related to a process which shares the signal handler table, the present mode of implementation allows an OS having a function of enabling sharing of a signal handler table among a plurality of process to be coped with.

### First Exemplary Embodiment

Next, a first exemplary embodiment of the present invention will be described with reference to FIG. 21 and FIG. 22. The present exemplary embodiment corresponds to the first mode of implementation of the present invention.

In the present exemplary embodiment, the OS 1110 and a process A operate on a computer operable under the control of a program.

The OS 1110 in the present exemplary embodiment manages a signal 0 (signal value is 0), a signal 1 (signal value is 1) and a signal 2 (signal value is 2) as a signal, and stored in pair with a signal value in a signal handler table of each process is a start address of a signal handler to be executed when these signals are generated, to which signal handler table of a signal transmission destination process the reference will be made when a signal is generated to obtain a start address of a signal handler to be paired with a signal value and start the signal handler. The OS 1110 further has a secure OS function to enable a security level to be set on a process basis, which enables security levels to be set, “Low” (non-privileged level) and “High” (privileged level) in the present exemplary embodiment. With an attribute value of a process being “Low” set to be 1 and an attribute value of a process being “High” set to be 3, a process set to have the security level “Low” has its privileged system call execution limited and a process set to have the security level “High” has no limitation to the execution of a privileged system call. Such an OS is, for example, SE Linux or may be other kind of OS.

Furthermore, the OS 1110 has the signal handler changing unit 1111, the signal handler returning unit 1112, the signal handler obtaining unit 1113, the security level changing unit 1114, the security level returning unit 1115, the signal processing unit 1116, the privileged instruction execution control unit 1117, the signal handler storing unit 1104 and the security level storing unit 1105. The OS 1110 further comprises, as a system call instruction, a system call 1 for calling up the signal handler changing unit 1111 as the first specific instruction, a system call 2 for calling up the signal handler returning unit 1112 as the second specific instruction, a system call 3 for calling up the signal handler obtaining unit 1113 as the third specific instruction, and a system call 4 for calling up the security level returning unit 1115 as the fourth specific instruction. The security level changing unit 1114 has a function of changing an attribute value of a process to 1 (security level “Low”). The security level returning unit 1115 has a function of returning an attribute value of a process to 3 (security level “High”).

The process A includes the function 1125, the signal handler hook function 1126, a signal handler As0 and a signal handler As1. The function 1125 is designed to have, among processing executed by the function itself, before execution of a specific processing section determined in advance, the system call 1 executed with a start address of the signal handler hook function 1126 as an argument and among the processing executed by the function itself, after the execution of the specific processing section, the system call 2 executed with the start address of the signal handler hook function 1126 as an argument. The signal handler hook function 1126 has, in the top part of the function, the system call 3 arranged which is to be executed with a received signal value as an argument and has the system call 4 arranged in the end part of the function. In addition, arranged immediately after the system call 3 is an instruction to execute, based on a start address of a signal handler to be obtained by the system call 3, the signal handler. The signal handler As0 is a signal handler to be executed when the signal 0 is transmitted to the process A and the signal handler As1 is a signal handler to be executed when the signal 1 is transmitted to the process A. In the process A, no signal handler is set for the signal 2. A signal handler table of the process A is illustrated in a state 1 in FIG. 22. An identifier of the process A is 1 and an attribute value of the process A is 3 (security level “High”).

Assume here that the process A calls up the function 1125 to execute the system call 1 arranged in the function 1125 with a start address of the signal handler hook function 1126 as an argument. When the system call 1 is executed, the signal handler changing unit 1111 will be called up. The signal handler changing unit 1111 stores the identifier 1 of the process A in pair with the signal handler table of the process A in the signal handler storing unit 1104. The signal handler table stored in the signal handler storing unit 1104 will be referred to as a default signal handler table A. Contents of the default signal handler table A are as shown in FIG. 22.

Next, the signal handler changing unit 1111 sets a signal search number to be the initial value 0. Since the OS 1110 here manages signals with the signal values 0 to 2, the maximum value of the signal search number is 2. Then, refer to a start address of a signal handler to be paired with the signal value 0 in the signal handler table of the process A. Since the signal value 0 is stored in pair with the top address of the signal handler As0, change the signal handler to the start address of the signal handler hook function 1126. Then, add 1 to the signal search number. Since the signal search number attains 1, refer to a start address of a signal handler to be paired with the signal value 1 in the signal handler table of the process A. Since the signal value 1 is stored to be paired with the top address of the signal handler As1, change the signal handler to the start address of the signal handler hook function 1126. Then, add 1 to the signal search number. Since the signal search number attains 2, refer to a start address of a signal handler to be paired with the signal value 2 in the signal handler table of the process A. Since no start address of a signal handler is set for the signal value 2, add 1 to the signal search number. The signal search number attains 3, which is larger than the maximum value of the signal search number, to end the processing of the system call 1. The signal handler table of the process A obtained then is illustrated in a state 2 in FIG. 22.

Assume that the process A executing the function 1125 receives the signal 1 after finishing the execution of the system call 1. Since the signal handler hook function 1126 is set as the signal handler for the signal 1 of the process A, the execution of the function 1125 is interrupted to execute the signal handler hook function 1126. Then, in the signal handler hook function 1126, the system call 3 is executed with the signal value 1 of the received signal 1 as an argument. When the system call 3 is executed, the signal handler obtaining unit 1113 will be called up.

With reference to the default signal handler table A to be paired with the identifier 1 of the process A, the signal handler obtaining unit 1113 obtains a start address of the signal handler As1 to be paired with the value 1 of the signal from the signal handler storing unit 1104. Then, call up the security level changing unit 1114 to wait for reception of a security level change completion signal.

The security level changing unit 1114 stores the identifier 1 and the attribute value 3 of the process A in pair in the security level storing unit 1105. Then, change the attribute value of the process A to 1 to transmit the security level change completion signal to the signal handler obtaining unit 1113.

Upon receiving the security level change completion signal, the signal handler obtaining unit 1113 gives the start address of the signal handler As1 obtained from the signal handler storing unit 1104 to the signal handler hook function 1126 to end the processing of the system call 3.

Based on the start address of the signal handler As1 obtained through the system call 3, the signal handler hook function 1126 calls up the signal handler As1.

Upon completion of the execution of the signal handler As1, the signal handler hook function 1126 executes the system call 4. When the system call 4 is executed, the security level returning unit 1115 will be called up.

The security level returning unit 1115 refers to the security level storing unit 1105 to obtain the attribute value 3 to be paired with the identifier 1 of the process A. Next, delete data formed of a pair of the identifier 1 and the attribute value 3 of the process A stored in the security level storing unit 1105. Then, change the attribute value of the process A to 3 to end the processing of the system call 4.

End of the processing of the system call 4 leads to end of the processing of the signal handler hook function 1126. When the processing of the signal handler hook function 1126 ends, the processing of the function 1125 resumes.

When the processing of the function 1125 resumes to execute the system call 2 arranged in the function 1125 with the top address of the signal handler hook function 1126 as an argument, the signal handler returning unit 1112 will be called up.

The signal handler returning unit 1112 refers to the signal handler storing unit 1104 to obtain the default signal handler table A to be paired with the identifier 1 of the process A. Next, the signal handler returning unit 1112 sets the signal search number to be the initial value 0. Since the OS 1110 here manages the signals whose signal values are 0 to 2, the maximum value of the signal search number is 2. Next, refer to a start address of a signal handler to be paired with the signal value 0 in the signal handler table of the process A. Since the signal value 0 is stored in pair with the top address of the signal handler hook function, change the signal handler to the signal handler As0 to be paired with the signal value 0 in the default signal handler table A. Next, add 1 to the signal search number. Since the signal search number attains 1, refer to a start address of a signal handler to be paired with the signal value 1 in the signal handler table of the process A. Since the signal value 1 is stored in pair with the top address of the signal handler hook function, change the signal handler to the signal handler As1 to be paired with the signal value 1 in the default signal handler table A. Next, add 1 to the signal search number. Since the signal search number attains 2, refer to a start address of a signal handler to be paired with the signal value 2 in the signal handler table of the process A. Since no start address of the signal handler is set for the signal 2, add 1 to the signal search number. Since the signal search number attains 3, which is larger than the maximum value of the signal search number, delete data formed of a pair of the identifier 1 of the process A and the default signal handler table A from the signal handler storing unit 1104 to end the processing of the system call 2.

### Second Exemplary Embodiment

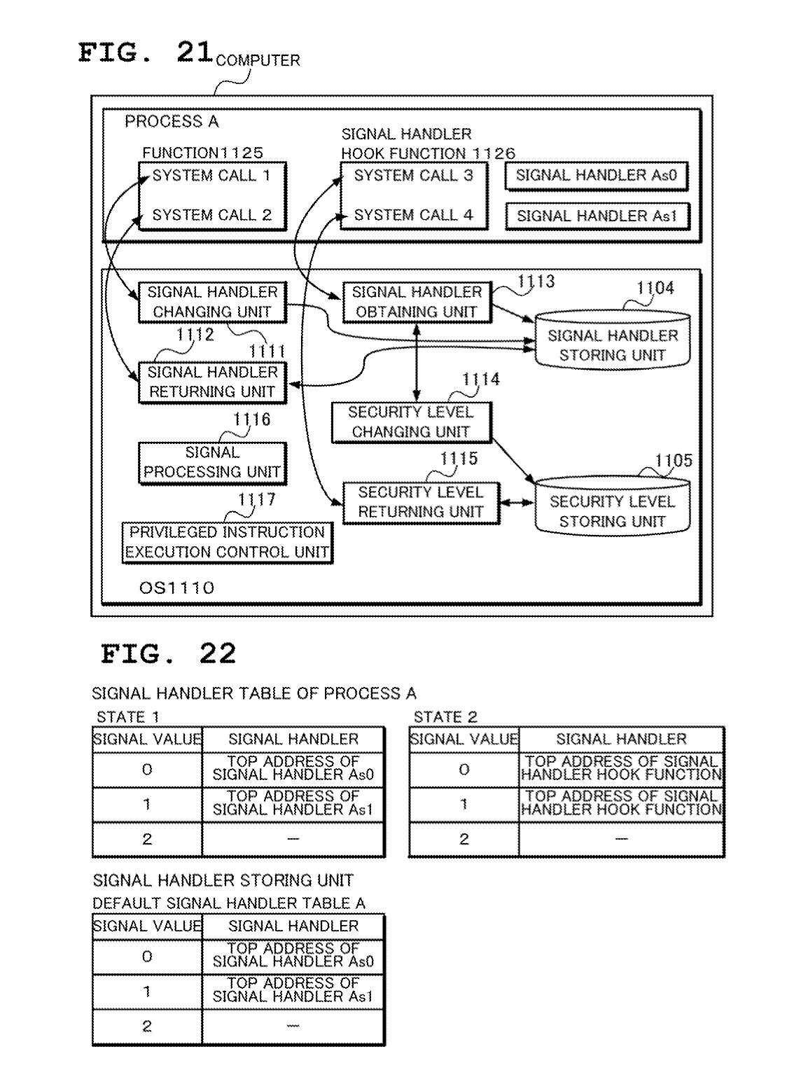

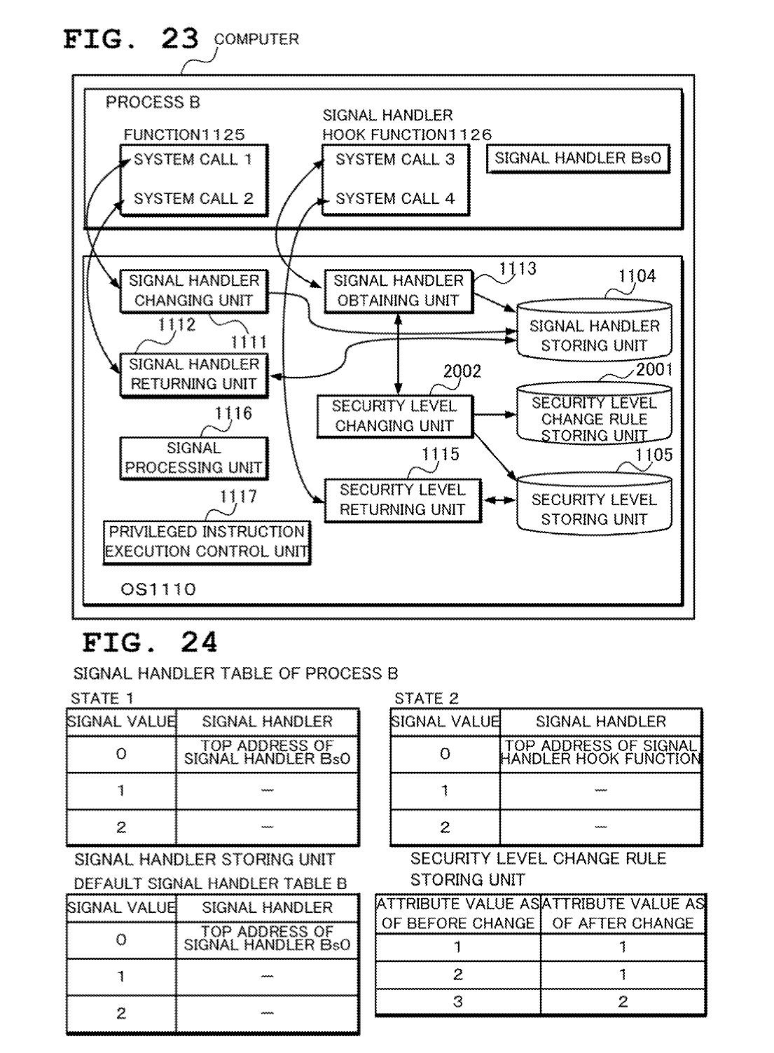

Next, a second exemplary embodiment of the present invention will be described with reference to FIG. 23 and FIG. 24. The present exemplary embodiment corresponds to the second mode of implementation of the present invention.

The present exemplary embodiment differs from the first exemplary embodiment in that a process operable on a computer is a process B and the OS 1110 has the security level change rule storing unit 2001. The OS 1110 in the present exemplary embodiment manages a signal 0 (signal value is 0), a signal 1 (signal value is 1) and a signal 2 (signal value is 2) as a signal, and stored in pair with a signal value in a signal handler table of each process is a start address of a signal handler to be executed when these signals are generated, to which signal handler table of a signal transmission destination process the reference will be made when a signal is generated to obtain a start address of a signal handler to be paired with a signal value and start the signal handler. The OS 1110 further has a secure OS function to enable a security level to be set on a process basis, which enables, in the present exemplary embodiment, security levels to be set, “Low” (non-privileged level), “Mid” (ordinary authorization level) and “High” (privileged level), and with an, attribute value of a process being “Low” set to be 1, an attribute value of a process being “Mid” set to be 2 and an attribute value of a process being “High” set to be 3, a process set to have the security level “Low” has its privileged system call execution limited, a process set to have the security level “Mid” has only the execution of several privileged system calls limited and a process set to have the security level “High” has no limitation to the execution of a privileged system call. Such an OS is, for example, SE Linux or may be other kind of OS.

Furthermore, the security level change rule storing unit 2001 has such change rules stored as shown in FIG. 24.

The process B includes the function 1125, the signal handler hook function 1126 and a signal handler Bs0. The signal handler Bs0 is a signal handler to be executed when the signal 0 is transmitted to the process B. The process B has no signal handler set for the signal 1 and the signal 2. Signal handler table of the process B is illustrated in a state 1 in FIG. 24. Identifier of the process B is 1 and an attribute value of the process B is 3 (security level “High”).

Assume here that the process B calls up the function 1125 to execute the system call 1 arranged in the function with a start address of the signal handler hook function 1126 as an argument. When the system call 1 is executed, the signal handler changing unit 1111 will be called up.

The signal handler changing unit 1111 stores the identifier 1 of the process B in pair with the signal handler table of the process B in the signal handler storing unit 1104. The signal handler table stored in the signal handler table storing unit 1104 will be referred to as a default signal handler table B. Contents are as shown in FIG. 24. Next, the signal handler changing unit 1111 sets a signal search number to be the initial value 0. Since the OS 1110 here manages signals with the signal values 0 to 2, the maximum value of the signal search number is 2. Next, refer to a start address of a signal handler to be paired with the signal value 0 in the signal handler table of the process B. Since the signal value 0 is stored in pair with the top address of the signal handler Bs0, change the signal handler to the start address of the signal handler hook function 1126. Then, add 1 to the signal search number. Since the signal search number attains 1, refer to a start address of a signal handler to be paired with the signal value 1 in the signal handler table of the process B. Since the signal value 1 has no start address of the signal handler set, add 1 to the signal search number. Since the signal search number attains 2, refer to a start address of a signal handler to be paired with the signal value 2 in the signal handler table of the process B. Since no signal handler is set for the signal value 2, add 1 to the signal search number. The signal search number attains 3, which is larger than the maximum value of the signal search number, to end the processing of the system call 1. The signal handler table of the process B obtained then is illustrated in a state 2 in FIG. 24

Assume that the process B executing the function 1125 receives the signal 0 after finishing the execution of the system call 1. Since the signal handler hook function 1126 is set as the signal handler for the signal 0 of the process B, the execution of the function 1125 is interrupted to execute the signal handler hook function 1126.

The signal handler hook function 1126 executes the system call 3 with the signal value 0 of the received signal 0 as an argument. When the system call 3 is executed, the signal handler obtaining unit 1113 will be called up.

With reference to the default signal handler table B to be paired with the identifier 1 of the process B, the signal handler obtaining unit 1113 obtains a start address of the signal handler Bs0 to be paired with the value 0 of the signal from the signal handler storing unit 1104. Then, call up the security level changing unit 2002 to wait for reception of a security level change completion signal.

The security level changing unit 2002 stores the identifier 1 and the attribute value 3 of the process B in pair in the security level storing unit 1105. Then, refer to the security level change rule storing unit 2001 to obtain the attribute value 2 to be paired with the attribute value 3 yet to be changed (attribute value of the process B). Then, change the attribute value of the process B to 2 to transmit the security level change completion signal to the signal handler obtaining unit 1113.

Upon receiving the security level change completion signal, the signal handler obtaining unit 1113 gives the start address of the signal handler Bs0 obtained from the signal handler storing unit 1104 to the signal handler hook function 1126 to end the processing of the system call 3.

Based on the start address of the signal handler Bs0 obtained through the system call 3, the signal handler hook function 1126 calls up the signal handler Bs0. Then, upon completion of the execution of the signal handler Bs0, the signal handler hook function 1126 executes the system call 4.

When the system call 4 is executed, the security level returning unit 1115 will be called up. The security level returning unit 1115 refers to the security level storing unit 1105 to obtain the attribute value 3 to be paired with the identifier 1 of the process B. Then, delete data formed of a pair of the identifier 1 and the attribute value 3 of the process B stored in the security level storing unit 1105. Then, change the attributer value of the process B to 3 to end the processing of the system call 4. End of the processing of the system call 4 leads to end of the processing of the signal handler hook function 1126. When the processing of the signal handler hook function 1126 ends, the processing of the function 1125 resumes.

The processing of the function 1125 resumes to execute the system call 2 arranged in the function with the top address of the signal handler hook function 1126 as an argument. When the system call 2 is executed, the signal handler returning unit 1112 will be called up.

The signal handler returning unit 1112 refers to the signal handler storing unit 1104 to obtain the default signal handler table B to be paired with the identifier 1 of the process B. Next, the signal handler returning unit 1112 sets the signal search number to be the initial value 0. Since the OS here manages the signals whose signal values are 0 to 2, the maximum value of the signal search number is 2. Next, refer to a start address of a signal handler to be paired with the signal value 0 in the signal handler table of the process B. Since the signal value 0 is stored in pair with the top address of the signal handler hook function 1126, change the signal handler to the signal handler Bs0 to be paired with the signal value 0 in the default signal handler table B. Then, add 1 to the signal search number. Since the signal search number attains 1, refer to a start address of a signal handler to be paired with the signal value 1 in the signal handler table of the process B. Since the signal value 1 has no start address of a signal handler set, add 1 to the signal search number. Since the signal search number attains 2, refer to a start address of a signal handler to be paired with the signal value 2 in the signal handler table of the process B. Since no signal handler is set for the signal 2, add 1 to the signal search number. Since the signal search number attains 3, which is larger than the maximum value of the signal search number, delete data formed of a pair of the identifier 1 of the process B and the default signal handler table B from the signal handler storing unit 1104 to end the processing of the system call 2.

### Third Exemplary Embodiment

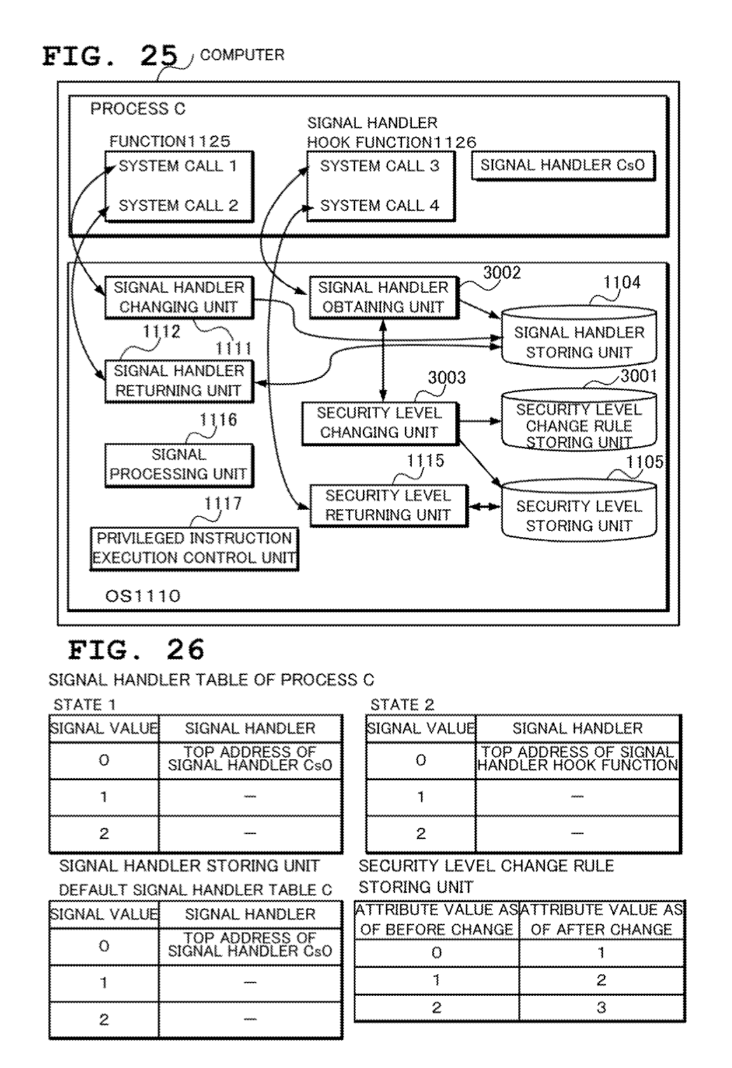

Next, a third exemplary embodiment of the present invention will be described with reference to FIG. 25 and FIG. 26. The present exemplary embodiment corresponds to the third mode of implementation of the present invention.

The present exemplary embodiment differs from the first exemplary embodiment in that a process operable on a computer is a process C and the OS 1110 has the security level change rule storing unit 3001. The OS 1110 in the present exemplary embodiment manages a signal 0 (signal value is 0), a signal 1 (signal value is 1) and a signal 2 (signal value is 2) as a signal, and stored in pair with a signal value in a signal handler table of each process is a start address of a signal handler to be executed when these signals are generated, to which signal handler table of a signal transmission destination process the reference will be made when a signal is generated to obtain a start address of a signal handler to be paired with a signal value and start the signal handler. The OS 1110 further has a secure OS function to enable a security level to be set on a process basis, which enables, in the present exemplary embodiment, security levels to be set, “Low” (non-privileged level), “Mid” (ordinary authorization level) and “High” (privileged level), and with an attribute value of a process being “Low” set to be 1, an attribute value of a process being “Mid” set to be 2 and an attribute value of a process being “High” set to be 3, a process set to have the security level “Low” has its privileged system call execution limited, a process set to have the security level “Mid” has only the execution of several privileged system calls limited and a process set to have the security level “High” has no limitation to the execution of a privileged system call. Such an OS is, for example, SE Linux or may be other kind of OS.

Furthermore, the OS 1110 has the signal handler changing unit 111, the signal handler returning unit 1112, the signal handler obtaining unit 3002, the security level changing unit 3003, the security level returning unit 1115, the signal handler storing unit 1104, the security level storing unit 1105 and the security level change rule storing unit 3001 arranged and comprises a system call 1 for calling up the signal handler changing unit 1111 as the first specific instruction, a system call 2 for calling up the signal handler returning unit 1112 as the second specific instruction, a system call 3 for calling up the signal handler obtaining unit 3002 as the third specific instruction, and a system call 4 for calling up the security level returning unit 1115 as the fourth specific instruction. The security level change rule storing unit 3001 has change rules stored whose contents are as shown in FIG. 26.

The process C includes the function 1125, the signal handler hook function 1126 and a signal handler Cs0. The function 1125 is designed to have, among processing executed by the function itself, before execution of a specific processing execution section determined in advance, the system call 1 executed with a start address of the signal handler hook function 1126 as an argument and among the processing executed by the function itself, after the execution of the specific processing execution section, the system call 2 executed with the start address of the signal handler hook function 1126 as an argument. The signal handler hook function 1126 has, in the top part of the function, the system call 3 arranged which is to be executed with a received signal value as an argument and has the system call 4 arranged in the end part of the function. In addition, arranged immediately after the system call 3 is an instruction to execute, based on a start address of a signal handler to be obtained by the system call 3, the signal handler. The signal handler Cs0 is a signal handler to be executed when the signal 0 is transmitted to the process C and in the process C, no signal handler is set for the signal 1 and the signal 2. A signal handler table of the process C is illustrated in a state 1 in FIG. 26. An identifier of the process C is 1 and an attribute value of the process C is 3 (security level “High”).

Assume here that the process C calls up the function 1125 to execute the system call 1 arranged in the function 1125 with a start address of the signal handler hook function 1126 as an argument. When the system call 1 is executed, the signal handler changing unit 1111 will be called up.

The signal handler changing unit 1111 stores the identifier 1 of the process C in pair with the signal handler table of the process C in the signal handler storing unit 1104. The signal handler table stored in the signal handler storing unit 1104 will be referred to as a default signal handler table C. States of the default signal handler table C are as shown in FIG. 26.

Next, the signal handler changing unit 1111 sets a signal search number to be the initial value 0. Since the OS here manages signals with the signal values 0 to 2, the maximum value of the signal search number is 2. Next, refer to a start address of a signal handler to be paired with the signal value 0 in the signal handler table of the process C. Since the signal value 0 is stored in pair with the top address of the signal handler Cs0, change the signal handler to the start address of the signal handler hook function 1126. Then, add 1 to the signal search number. Since the signal search number attains 1, refer to a start address of a signal handler to be paired with the signal value 1 in the signal handler table of the process C. Since no start address of a signal handler is set for the signal value 1, add 1 to the signal search number. Since the signal search number attains 2, refer to a start address of a signal handler to be paired with the signal value 2 in the signal handler table of the process C. Since no signal handler is set for the signal value 2, add 1 to the signal search number. The signal search number attains 3, which is larger than the maximum value of the signal search number, to end the processing of the system call 1. The signal handler table of the process C obtained then is illustrated in a state 2 in FIG. 26.

Assume that the process C executing the function 1125 receives the signal 0 after finishing the execution of the system call 1. Since the signal handler hook function 1126 is set as the signal handler for the signal 0 of the process C, the execution of the function 1125 is interrupted to execute the signal handler hook function 1126. Then, in the signal handler hook function 1126, the system call 3 is executed with the signal value 0 of the received signal 0 as an argument. When the system call 3 is executed, the signal handler obtaining unit 3002 will be called up.

With reference to the default signal handler table C to be paired with the identifier 1 of the process C, the signal handler obtaining unit 3002 obtains a start address of the signal handler Cs0 to be paired with the value 0 of the signal from the signal handler storing unit 1104. Then, call up the security level changing unit 3003 to give the signal value 0. Then, wait for reception of a security level change completion signal.

The security level changing unit 3003 stores the identifier 1 and the attribute value 3 of the process C in pair in the security level storing unit 1105. Next, with reference to the security level change rule storing unit 3001, obtain the attribute value 1 to be paired with the signal value 0. Then, change the attribute value of the process C to 1 to transmit the security level change completion signal to the signal handler obtaining unit 3002.

Upon receiving the security level change completion signal, the signal handler obtaining unit 3002 gives the start address of the signal handler Cs0 obtained from the signal handler storing unit 1104 to the signal handler hook function 1126 to end the processing of the system call 3.

Based on the start address of the signal handler Cs0 obtained through the system call 3, the signal handler hook function 1126 calls up the signal handler Cs0. Then, upon completion of the execution of the signal handler Cs0, the signal handler hook function 1126 executes the system call 4. When the system call 4 is executed, the security level returning unit 1115 will be called up.

The security level returning unit 1115 refers to the security level storing unit 1105 to obtain the attribute value 3 to be paired with the identifier 1 of the process C. Next, delete data formed of a pair of the identifier 1 and the attribute value 3 of the process C stored in the security level storing unit 1105. Then, change the attributer value of the process C to 3 to end the processing of the system call 4. End of the processing of the system call 4 leads to end of the processing of the signal handler hook function 1126. When the processing of the signal handler hook function 1126 ends, the processing of the function 1125 resumes.

When the processing of the function 1125 resumes to execute the system call 2 arranged in the function with the top address of the signal handler hook function 1126 as an argument, the signal handler returning unit 1112 will be called up.

The signal handler returning unit 1112 refers to the signal handler storing unit 1104 to obtain the default signal handler table C to be paired with the identifier 1 of the process C. Next, the signal handler returning unit 1112 sets the signal search number to be the initial value 0. Since the OS here manages the signals whose signal values are 0 to 2, the maximum value of the signal search number is 2. Then, refer to a start address of a signal handler to be paired with the signal value 0 in the signal handler table of the process C. Since the signal value 0 is stored in pair with the top address of the signal handler hook function 1126, change the signal handler to the signal handler Cs0 to be paired with the signal value 0 in the default signal handler table C. Then, add 1 to the signal search number. Since the signal search number attains 1, refer to a start address of a signal handler to be paired with the signal value 1 in the signal handler table of the process C. Since no start address of the signal handler is set for the signal value 1, add 1 to the signal search number. Since the signal search number attains 2, refer to a start address of a signal handler to be paired with the signal value 2 in the signal handler table of the process C. Since no signal handler is set for the signal value 2, add 1 to the signal search number. Since the signal search number attains 3, which is larger than the maximum value of the signal search number, delete data formed of a pair of the identifier 1 of the process C and the default signal handler table C from the signal handler storing unit 1104 to end the processing of the system call 2.

### Fourth Exemplary Embodiment

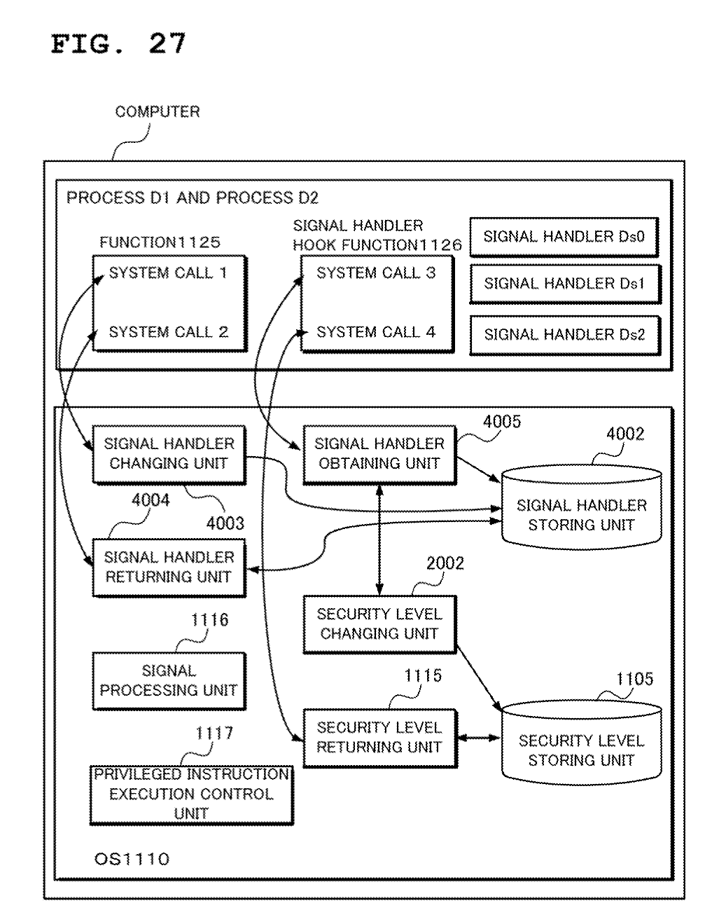

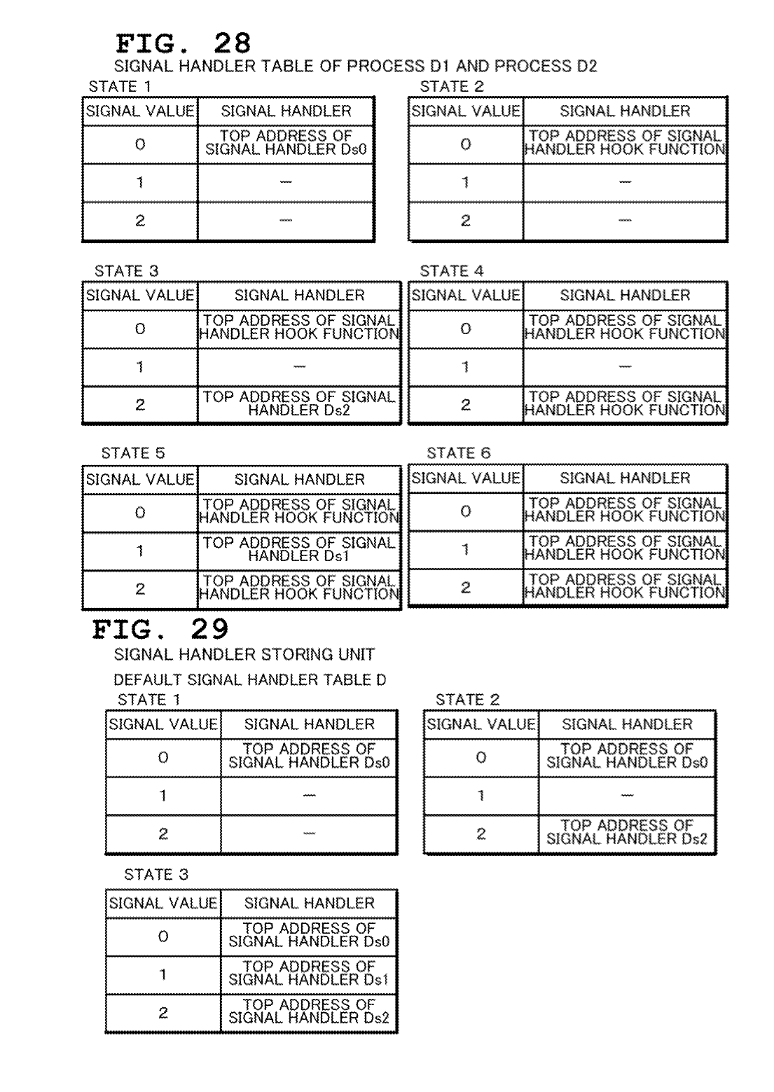

Next, a fourth exemplary embodiment of the present invention will be described with reference to FIG. 27, FIG. 28 and FIG. 29. The present exemplary embodiment corresponds to the fourth mode of implementation of the present invention.

In the present exemplary embodiment, the OS 1110 and processes D1 and D2 operate on a computer operable under the control of a program.

The OS 1110 manages a signal 0 (signal value is 0), a signal 1 (signal value is 1) and a signal 2 (signal value is 2) as a signal, and stored in pair with a signal value in a signal handler table of each process is a start address of a signal handler to be executed when these signals are generated, to which signal handler table of a signal transmission destination process the reference will be made when a signal is generated to obtain a start address of a signal handler to be paired with a signal value and start the signal handler. Under the OS 1110, a signal handler table can be shared by a plurality of processes (threads). The OS 1110 further has a secure OS function to enable a security level to be set on a process basis, which enables, in the present exemplary embodiment, security levels to be set, “Low” (non-privileged level) and “High” (privileged level), and with an attribute value of a process being “Low” set to be 1 and an attribute value of a process being “High” set to be 3, a process set to have the security level “Low” has its privileged system call execution limited and a process set to have the security level “High” has no limitation to the execution of a privileged system call. Such an OS is, for example, SE Linux or may be other kind of OS.

Furthermore, the OS 1110 has the signal handler changing unit 4003, the signal handler returning unit 4004, the signal handler obtaining unit 4005, the security level changing unit 1114, the security level returning unit 1115, the signal handler storing unit 4002, and the security level storing unit 1105, and further comprises a system call 1 for calling up the signal handler changing unit 4003 as the first specific instruction, a system call 2 for calling up the signal handler returning unit 4004 as the second specific instruction, a system call 3 for calling up the signal handler obtaining unit 4005 as the third specific instruction, and a system call 4 for calling up the security level returning unit 1115 as the fourth specific instruction. The security level changing unit 1114 has a function of changing an attribute value of a process to 1 (security level “Low”).

The process D1 and the process D2 are threads of the same program and share a signal handler table. The process D1 and the process D2 include the function 1125, the signal handler hook function 1126, a signal handler Ds0, a signal handler Ds1 and a signal handler Ds2. The function 1125 is designed to have, among processing executed by the function itself, before execution of a specific processing execution section determined in advance, the system call 1 executed with a start address of the signal handler hook function 1126 as an argument and among the processing executed by the function itself, after the execution of the specific processing execution section, the system call 2 executed with the start address of the signal handler hook function 1126 as an argument. In addition, immediately preceding the system call 2 of the function 1125, an instruction is arranged to set the signal handler Ds1 as a signal handler of the signal 1. The signal handler hook function 1126 has, in the top part of the function, the system call 3 arranged which is to be executed with a received signal value as an argument and has the system call 4 arranged in the end part of the function. In addition, arranged immediately after the system call 3 is an instruction to execute, based on a start address of a signal handler to be obtained by the system call 3, the signal handler. The signal handler Ds0 is a signal handler to be executed when the signal 0 is transmitted to the process D1 or the process D2. In the process D1 and the process D2, no signal handler is set for the signal 1 and the signal 2. A signal handler table of the process D1 and the process D2 is illustrated in a state 1 in FIG. 28. An identifier of the process D1 is 1 and an identifier of the process D2 is 2, and an attribute value of the process D1 and the process D2 is 3 (security level “High”).

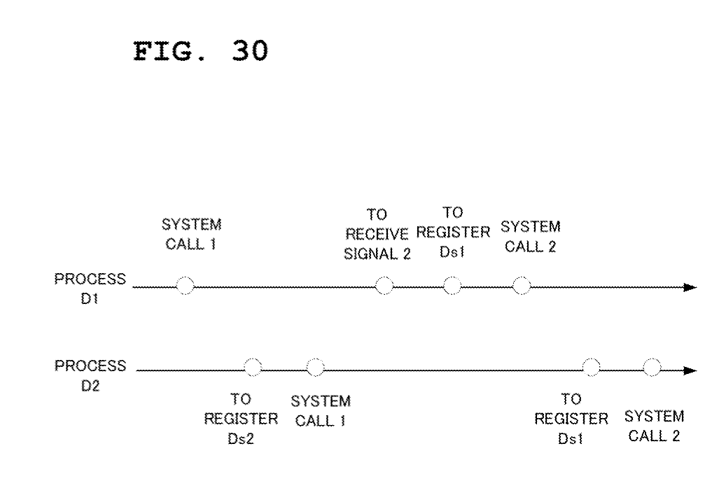

Operation of the present exemplary embodiment will be described assuming here that the process D1 and the process D2 here operate in a manner as shown in FIG. 30.

First, when the process D1 calls up the function 1125 to execute the system call 1 arranged in the function with the start address of the signal handler hook function 1126 as an argument, the signal handler changing unit 4003 will be called up.

Since the process D1 shares the signal handler table with the process D2, the signal handler changing unit 4003 determines whether the identifier 2 of the process D2 is stored in a process identifier group in the signal handler storing unit 4002. In this example, since no process identifier group including the identifier 2 is stored in the signal handler storing unit 4002, take the identifier 1 of the process D1 as a process identifier group and store the same in pair with the signal handler table of the process D1. The signal handler table stored in the signal handler storing unit 4002 will be referred to as a default signal handler table D. The default signal handler table D obtained then has a state 1 shown in FIG. 29.

Next, the signal handler changing unit 4003 sets a signal search number to be the initial value 0. Since the OS here manages signals with the signal values 0 to 2, the maximum value of the signal search number is 2. Then, refer to a start address of a signal handler to be paired with the signal value 0 in the signal handler table of the process D1. Since the signal value 0 is stored in pair with the top address of the signal handler Ds0, change the signal handler to the start address of the signal handler hook function 1126. Then, add 1 to the signal search number. Since the signal search number attains 1, refer to a start address of a signal handler to be paired with the signal value 1 in the signal handler table of the process D1. Since no start address of the signal handler is set for the signal value 1, add 1 to the signal search number. Since the signal search number attains 2, refer to a start address of a signal handler to be paired with the signal value 2 in the signal handler table of the process D1. Since no signal handler is set for the signal value 2, add 1 to the signal search number. The signal search number attains 3, which is larger than the maximum value of the signal search number, to end the processing of the system call 1. State of the signal handler table shared by the process D1 and the process D2 obtained then is illustrated in a state 2 in FIG. 28.

Assume that after the execution of the system call 1 is finished in the process D1, the process D2 registers the signal handler Ds2 as a signal handler of the signal 2 (state 3 in FIG. 28) to call up the function 1125. At this time, the system call 2 in the function 1125 is yet to be executed in the process D1. The process D2 executes the system call 1 arranged in the function with the start address of the signal handler hook function 1126 as an argument. When the system call 1 is executed, the signal handler changing unit 4003 will be called up.

Since the process D2 shares the signal handler table with the process D1, the signal handler changing unit 4003 determines whether the identifier 1 of the process D1 is stored in a process identifier group in the signal handler storing unit 4002. Since in the signal handler storing unit 4002, there is a process identifier group which stores the identifier 1, add the identifier 2 of the process D2 to the process identifier group. Next, refer to the default signal handler table D to be paired with the process identifier group. Next, the signal handler changing unit 4003 sets the signal search number to be the initial value 0. Since the OS here manages signals whose signal values are 0 to 2, the maximum value of the signal search number is 2. Then, refer to a start address of a signal handler to be paired with the signal value 0 in the signal handler table of the process D2. Since the signal value 0 has the top address of the signal handler hook function 1126 set, add 1 to the signal search number. Since the signal search number attains 1, refer to a start address of a signal handler to be paired with the signal value 1 in the signal handler table of the process D2. Since no start address of the signal handler is set for the signal value 1, add 1 to the signal search number. Since the signal search number attains 2, refer to a start address of a signal handler to be paired with the signal value 2 in the signal handler table of the process D2. Since the top address of the signal handler Ds2 is stored for the signal value 2, store the signal handler Ds2 in pair with the signal value 2 of the default signal handler D. Then, change the pair with the signal value 2 in the signal handler table of the process D2 to the top address of the signal handler hook function 1126. Then, add 1 to the signal search number. The signal search number attains 3, which is larger than the maximum value of the signal search number, to end the processing of the system call 1.

Signal handler table shared by the process D1 and the process D2 then is illustrated in a state 4 in FIG. 28. Contents of the default signal handler table D are shown in a state 2 in FIG. 29.

Assume here that the process D1 receives the signal 2. Since the signal handler hook function 1126 is set for the signal handler of the signal 2 of the process D1, execution of the function 1125 is interrupted to execute the signal handler hook function 1126. Then, in the signal handler hook function 1126, the system call 3 is executed with the signal value 2 of the received signal 2 as an argument. When the system call 3 is executed, the signal handler obtaining unit 4005 will be called up.

With reference to the default signal handler table D to be paired with the process identifier group which stores the identifier 1 of the process D1, the signal handler obtaining unit 4005 obtains a start address of the signal handler Ds2 to be paired with the signal value 2 from the signal handler storing unit 4002. Then, call up the security level changing unit 1114 to wait for reception of a security level change completion signal.

The security level changing unit 1114 stores the identifier 1 and the attribute value 3 of the process D1 in pair in the security level storing unit 1105. Then, change the attribute value of the process D1 to 1 to transmit the security level change completion signal to the signal handler obtaining unit 4005.

Upon receiving the security level change completion signal, the signal handler obtaining unit 4005 gives the start address of the signal handler Ds2 obtained from the signal handler storing unit 4002 to the signal handler hook function 1126 to end the processing of the system call 3.

Based on the start address of the signal handler Ds2 obtained through the system call 3, the signal handler hook function 1126 calls up the signal handler Ds2. Upon completion of the execution of the signal handler Ds2, the signal handler hook function 1126 executes the system call 4. When the system call 4 is executed, the security level returning unit 1115 will be called up.

The security level returning unit 1115 refers to the security level storing unit 1105 to obtain the attribute value 3 to be paired with the identifier 1 of the process D1. Next, delete data formed of a pair of the identifier 1 and the attribute value 3 of the process D1 stored in the security level storing unit 1105. Next, change the attribute value of the process D1 to 3 to end the processing of the system call 4. End of the processing of the system call 4 leads to end of the processing of the signal handler hook function 1126. When the processing of the signal handler hook function 1126 ends, processing of the function 1125 of the process D1 resumes.

Assume that after the process D1 resumes the processing of the function 1125 to execute an instruction arranged in the function to set the signal handler Ds1 as a signal handler of the signal 1 (the signal handler table enters a state 5 in FIG. 28), the system call 2 is executed with a top address of the signal handler hook function 1126 as an argument. At this time, the system call 2 is yet to be executed in the function 1125 of the process D2. When the system call 2 is executed, the signal handler returning unit 4004 will be called up.

The signal handler returning unit 4004 refers to the signal handler storing unit 4002 to find a process identifier group including the identifier 1 of the process D1. In this case, the identifier 2 exists in the process identifier group other than the identifier 1. Next, with reference to the default signal handler table D to be paired with the process identifier group, the signal handler returning unit 4004 sets the signal search number to be the initial value 0. Since the OS here manages the signals whose signal values are 0 to 2, the maximum value of the signal search number is 2. Then, refer to a start address of a signal handler to be paired with the signal value 0 in the signal handler table of the process D1. Since the top address of the signal handler hook function 1126 is set for the signal value 0, add 1 to the signal search number. Since the signal search number attains 1, refer to a start, address of a signal handler to be paired with the signal value 1 in the signal handler table of the process D1. Since the start address of the signal handler Ds1 is set for the signal value 1, store the signal handler Ds1 as a pair with the signal value 1 of the default signal handler D. Then, add 1 to the signal search number. Since the signal search number attains 2, refer to a start address of a signal handler to be paired with the signal value 2 in the signal handler table of the process D1. Since a top address of the signal handler hook function 1126 is set for the signal value 2, add 1 to the signal search number. Since the signal search number attains 3, which is larger than the maximum value of the signal search number, delete the identifier 1 from a process identifier group including the identifier of the process D1 in the signal handler storing unit 4002 to end the processing of the system call 2. Signal handler table shared by the process D1 and the process D2 then is illustrated in a state 6 in FIG. 28. Contents of the default signal handler table D are shown in a state 3 in FIG. 29.

Next, assume that after the process D2 resumes the processing of the function 1125 to execute an instruction arranged in the function to set the signal handler Ds1 as a signal handler of the signal 1 (the signal handler table enters the state 5 in FIG. 28), the system call 2 is executed with the top address of the signal handler hook function 1126 as an argument. When the system call 2 is executed, the signal handler returning unit 4004 will be called up.

The signal handler returning unit 4004 refers to the signal handler storing unit 4002 to find a process identifier group including the identifier 1 of the process D1 in the signal handler storing unit 4002. In this case, no other identifier than the identifier 2 exists in the process identifier group. The signal handler returning unit 4004 obtains the default signal handler table D to be paired with the process identifier group including the identifier 2 of the process D2. Next, the signal handler changing unit 4003 sets the signal search number to be the initial value 0. Since the OS here manages the signals whose signal values are 0 to 2, the maximum value of the signal search number is 2. Refer to a start address of a signal handler to be paired with the signal value 0 in the signal handler table of the process D2. Since the signal value 0 is stored in pair with the top address of the signal handler hook function 1126, change the signal handler to the signal handler Ds0 to be paired with the signal value 0 in the default signal handler table D. Then, add 1 to the signal search number. Since the signal search number attains 1, refer to a start address of a signal handler to be paired with the signal value 1 in the signal handler table of the process D2. Since the start address of the signal handler Ds1 is set for the signal value 1, add 1 to the signal search number. Since the signal search number attains 2, refer to a start address of a signal handler to be paired with the signal value 2 in the signal handler table of the process D2. Since the signal 2 is stored in pair with the top address of the signal handler hook function 1126, change the signal handler to the signal handler Ds2 to be paired with the signal value 2 in the default signal handler table D. Then, add 1 to the signal search number. Since the signal search number attains 3, which is larger than the maximum value of the signal search number, delete data formed of a pair of a process identifier group storing the identifier 2 of the process 2 and the default signal handler table D in the signal handler storing unit 4002 to end the processing of the system call 2.

When the signal 2 is received by the process D1 in a section from a time point where the process D1 executes the system call 2 to a time point where the process D2 executes the system call 2, the attribute value of the process D1 is changed to a non-privileged level to execute the signal handler Ds2 in the present exemplary embodiment. In addition, as in the above-described modification example of the fourth mode of implementation, in the exemplary embodiment where the security level changing unit 1114 checks whether the identifier of the process D1 is included in any of the process identifier groups in the signal handler storing unit 4002 and only when it is included, the attribute value of the process D1 is changed and otherwise, no attribute value is changed, when the signal 2 is received by the process D1 in a section from a time point where the process D1 executes the system call 2 until a time point where the process D2 executes the system call 2, the signal handler Ds2 is executed with the attribute value of the process D1 remaining at the privileged level.

In the modes of implementation of the present invention, when the process calls up a function including a first specific instruction and a second specific instruction, the first specific instruction is executed to cause an internal interruption before a processing section in which processing should be guaranteed by the function. In the processing related to the internal interruption, the signal handler changing unit stores (saves) a signal handler table of the process in pair with an identifier of the process in the signal handler storing unit. Subsequently, the signal handler changing unit refers to the signal handler table of the process to change the signal handler set at the signal handler table of the process to a signal handler hook function. Then, when a signal of a kind with a signal handler hook function set is generated during processing of the function having executed the first specific instruction, the signal handler hook function will be called up. In the signal handler hook function, the third specific instruction is executed to generate an internal interruption. In processing related to the internal interruption, the signal handler obtaining unit refers to a signal handler table to be paired with an identifier of the process stored in the signal handler storing unit to obtain, from the referred signal handler table, a signal handler to be paired with a kind of the signal received by the process. Subsequently, the signal handler obtaining unit calls up the security level changing unit. The security level changing unit changes the attribute value of the process to change a security level of the process so as not to be allowed to execute a privileged instruction. When the security level of the process is changed, the signal handler obtaining unit returns the signal handler obtained from the signal handler storing unit to a signal handler hook function. The signal handler hook function executes the obtained signal handler. When the privileged instruction is executed in this signal handler, an internal interruption occurs, so that the privileged instruction execution control unit determines whether to execute a privileged instruction according to an attribute value of the process. Since the attribute value of the process is here changed by the security level changing unit, the privileged instruction will not be executed to have an error. Thereafter, when the processing of the signal handler ends, the fourth specific instruction will be executed in the signal handler hook function to generate an internal interruption. In processing related to the internal interruption, the attribute value of the process is changed by the security level returning unit to return the security level of the process to a state as of before the change by the security level changing unit. Then, the processing of the signal handler hook function ends to again continue the processing of the function including the first specific instruction and the second specific instruction and execute the second specific instruction, so that an internal interruption occurs. In the processing related to the internal interruption, the signal handler table of the process is referred to by the signal handler returning unit. Then, when a signal handler set in the signal handler table is a signal handler hook function, refer to the signal handler storing unit to obtain a signal handler from a signal handler table to be paired with the process and change the signal handler of the process to a signal handler as of before being set at the signal handler hook function. The foregoing attains the object.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2007-041711, filed on Feb. 22, 2007, the disclosure of which is incorporated herein in its entirety by reference.

### INDUSTRIAL APPLICABILITY

The present invention is applicable to such usage as safely executing a process including processing of a signal handler whose reliability is unknown by an information processing device. Information processing device here is applicable to a wide range of devices such as a personal computer, a built-in computer of a mobile communication terminal such as a cellular phone or a PDA, a game playing machine and a multi-function copying machine.

1. An information processing device which executes a process under the control of an OS, comprising:
a storage device which holds a function for executing a first specific instruction before execution of a processing section whose normal execution might be hindered by unexpected processing of a signal handler and executing a second specific instruction after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table of a process, and a signal handler storing unit for saving a pair of an attribute value of a process and a signal handler table;
a signal handler changing unit for saving, when said process executes said first specific instruction, a pair of an identifier of said process and said signal handler table into said signal handler storing unit to change said signal handler set at said signal handler table of said process to said signal handler hook function;
a signal handler returning unit for returning, when said process executes said second specific instruction, said signal handler hook function set at said signal handler table of said process to said signal handler as of before setting of said signal handler hook function which is saved in said signal handler storing unit;
a signal handler obtaining unit for obtaining, when said process executes said third specific instruction, a signal handler to be paired with an identifier of said process and a kind of signal received by said process with reference to said signal handler storing unit;
a security level changing unit for changing said attribute value of said process after acquisition of a signal handler by said signal handler obtaining unit; and
a security level returning unit for changing said attribute value of said process to an attribute value as of before change when said process executes said fourth specific instruction.

2. An information processing device which executes a process under the control of an OS, comprising:
a storage device which holds a function for executing a first specific instruction before execution of a processing section whose normal execution might be hindered by unexpected processing of a signal handler and executing a second specific instruction after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table shared by a plurality of processes, and a signal handler storing unit for saving a pair of a process identifier group including an identifier of a process and a signal handler table;
a signal handler changing unit for, when a specific process among a plurality of processes sharing said signal handler table executes said first specific instruction, if no process identifier group including an identifier of other process is stored in said signal handler storing unit, after saving a pair of a process identifier group including an identifier of said specific process and said signal handler table into said signal handler storing unit, changing said signal handler set at said signal handler table to said signal handler hook function, and if a process identifier group including the identifier of said other process is stored in said signal handler storing unit, adding the identifier of said specific process to the process identifier group including the identifier of said other process, as well as adding said signal handler set at said signal handler table to a signal handler table in said signal handler storing unit which table is to be paired with said added process identifier group and thereafter changing said signal handler set at said signal handler table to said signal handler hook function;
a signal handler returning unit for, when said specific process executes said second specific instruction, if no process identifier group including an identifier of said other process is stored in said signal handler storing unit, after returning a signal handler for which said signal handler hook function is set in said signal handler table of said specific process to said signal handler as of before setting of said signal handler hook function which is saved in said signal handler storing unit, deleting data of a pair of a process identifier group including an identifier of said specific process and said signal handler table from said signal handler storing unit, and if a process identifier group including the identifier of said other process is stored in said signal handler storing unit, adding said signal handler set at said signal handler table of said specific process to a signal handler table in said signal handler storing unit which table is to be paired with said process identifier group to delete the identifier of said specific process from said process identifier group;
a signal handler obtaining unit for obtaining, when said process executes said third specific instruction, a signal handler to be paired with an identifier of said process and a kind of signal received by said process with reference to said signal handler storing unit;
a security level changing unit for changing said attribute value of said process after acquisition of a signal handler by said signal handler obtaining unit; and
a security level returning unit for changing said attribute value of said process to an attribute value as of before change when said process executes said fourth specific instruction.

3. The information processing device according to claim 2, wherein said security level changing unit, only when the identifier of said process whose attribute value is to be changed is included in a process identifier group of said signal handler storing unit, changes said attribute value of said process.

4. The information processing device according to claim 3, wherein said security level returning unit, only when the identifier of said process whose attribute value is to be returned is included in a process identifier group of said signal handler storing unit, changes said attribute value of said process.

5. The information processing device according to claim 1 or claim 2, wherein said attribute value is an attribute value indicative of a security level of said process.

6. The information processing device according to claim 1, wherein
said attribute value is an attribute value indicative of a security level of said process, and which comprises
a privileged instruction execution control unit for checking authorization based on a security level of said process and when authorization to execute a privileged instruction exists, executing the privileged instruction.

7. The information processing device according to claim 1, comprising
a security level change rule storing unit for holding a rule to change said attribute value, wherein
said security level changing unit changes said attribute value based on a rule stored in said security level change rule storing unit.

8. The information processing device according to claim 7, wherein
in said security level change rule storing unit, a pair of an attribute value as of before change of said attribute value and an attribute value as of after change is stored, and
said security level changing unit changes said attribute value of said process to an attribute value as of after change which is to be paired with an attribute value as of before change which is equal to said attribute value of said process stored in said security level change rule storing unit.

9. The information processing device according to claim 7, wherein
in said security level change rule storing unit, a pair of a value of a signal and said attribute value is stored, and
said security level changing unit changes said attribute value of said process to an attribute value to be paired with a value of a signal received by said process which value is stored in said security level change rule storing unit.

10. An information processing method of executing a process under the control of an OS by an information processing device, wherein
said information processing device holds, in a storage device, a function for executing a first specific instruction before execution of a processing section whose normal execution might be hindered by unexpected processing of a signal handler and executing a second specific instruction immediately after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table of a process, and a signal handler storing unit for saving a pair of an attribute value of a process and a signal handler table, said method comprising:
a signal handler changing step of saving, when said process executes said first specific instruction, a pair of an identifier of said process and said signal handler table into said signal handler storing unit to change said signal handler set at said signal handler table of said process to said signal handler hook function;
a signal processing step of determining a signal handler corresponding to a signal received during execution of said process with reference to said signal handler table and when the determined signal handler is said signal handler hook function, calling up said signal handler hook function;
a signal handler obtaining step of obtaining, when said process executes said third specific instruction of said signal handler hook function, a signal handler to be paired with an identifier of said process and a kind of signal received at said process with reference to said signal handler storing unit;
a security level changing step of changing said attribute value of said process after acquisition of a signal handler at said signal handler obtaining step;
a security level returning step of changing, when said process executes said fourth specific instruction after executing the signal handler obtained at said signal handler obtaining step in said signal handler hook function, said attribute value of said process to an attribute value as of before change; and
a signal handler returning step of returning, when said process executes said second specific instruction of said function, said signal handler hook function set at said signal handler table of said process to said signal handler as of before setting of said signal handler hook function saved in said signal handler storing unit.

11. An information processing method of executing a process under the control of an OS by an information processing device, wherein
said information processing device holds, in a storage device, a function for executing a first specific instruction before execution of a processing section whose normal execution might be hindered by unexpected processing of a signal handler and executing a second specific instruction immediately after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table shared by a plurality of processes, and a signal handler storing unit for saving a pair of a process identifier group including an identifier of a process and a signal handler table, said method comprising:
a signal handler changing step of, when a specific process among a plurality of processes sharing said signal handler table executes said first specific instruction, if no process identifier group including an identifier of other process is stored in said signal handler storing unit, after saving a pair of a process identifier group including an identifier of said specific process and said signal handler table into said signal handler storing unit, changing said signal handler set at said signal handler table to said signal handler hook function, and if a process identifier group including the identifier of said other process is stored in said signal handler storing unit, adding the identifier of said specific process to the process identifier group including the identifier of said other process, as well as adding said signal handler set at said signal handler table to a signal handler table in said signal handler storing unit which table is to be paired with said added process identifier group and thereafter changing said signal handler set at said signal handler table to said signal handler hook function;
a signal processing step of determining a signal handler corresponding to a signal received during execution of said process with reference to said signal handler table and when the determined signal handler is said signal handler hook function, calling up said signal handler hook function;
a signal handler obtaining step of obtaining, when said process executes said third specific instruction of said signal handler hook function, a signal handler to be paired with an identifier of said process and a kind of signal received by said process with reference to said signal handler storing unit;
a security level changing step of changing said attribute value of said process after acquisition of a signal handler at said signal handler obtaining step; and
a signal handler returning step of returning, when said specific process executes said second specific instruction, if no process identifier group including an identifier of said other process is stored in said signal handler storing unit, after returning a signal handler for which said signal handler hook function is set in said signal handler table of said first process to said signal handler as of before setting of said signal handler hook function which is saved in said signal handler storing unit, deleting data of a pair of a process identifier group including an identifier of said first process and said signal handler table from said signal handler storing unit, and if a process identifier group including an identifier of said second process is stored in said signal handler storing unit, adding said signal handler set at said signal handler table of said specific process to a signal handler table in said signal handler storing unit which table is to be paired with said process identifier group to delete the identifier of said specific process from said process identifier group.

12. The information processing method according to claim 11, wherein at said security level changing step, only when the identifier of said process whose attribute value is to be changed is included in a process identifier group of said signal handler storing unit, said attribute value of said process is changed.

13. The information processing method according to claim 12, wherein at said security level returning step, only when the identifier of said process whose attribute value is to be returned is included in a process identifier group of said signal handler storing unit, said attribute value of said process is changed.

14. The information processing method according to claim 10, wherein said attribute value is an attribute value indicative of a security level of said process.

15. The information processing method according to claim 10, wherein
said attribute value is an attribute value indicative of a security level of said process, and which comprising
a privileged instruction execution controlling step of checking authorization based on a security level of said process and when authorization to execute a privileged instruction exists, executing the privileged instruction.

16. The information processing method according to claim 10, wherein said information processing device comprises a security level change rule storing unit for holding a rule to change said attribute value, wherein
at said security level changing step, said attribute value is changed based on a rule stored in said security level change rule storing unit.

17. The information processing method according to claim 16, wherein
in said security level change rule storing unit, a pair of an attribute value as of before change of said attribute value and an attribute value as of after change is stored, and
at said security level changing step, said attribute value of said process is changed to an attribute value as of after change which is to be paired with an attribute value as of before change which is equal to said attribute value of said process stored in said security level change rule storing unit.

18. The information processing method according to claim 16, wherein
in said security level change rule storing unit, a pair of a value of a signal and said attribute value is stored, and
at said security level changing step, said attribute value of said process is changed to an attribute value to be paired with a value of a signal received by said process which value is stored in said security level change rule storing unit.

19. A computer readable medium storing a program implemented in an information processing device which executes a process under the control of an OS, wherein
said information processing device includes a storage device holding a function for executing a first specific instruction before execution of a processing section whose normal execution might be hindered by unexpected processing of a signal handler and executing a second specific instruction immediately after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table of a process, and a signal handler storing unit for saving a pair of an attribute value of a process and a signal handler table, wherein
said program causing said information processing device to execute processing of:
a signal handler changing processing of saving, when said process executes said first specific instruction, a pair of an identifier of said process and said signal handler table into said signal handler storing unit to change said signal handler set at said signal handler table of said process to said signal handler hook function;
a signal handler returning processing of returning, when said process executes said second specific instruction, said signal handler hook function set at said signal handler table of said process to said signal handler as of before setting of said signal handler hook function saved in said signal handler storing unit;
a signal handler obtaining processing of obtaining, when said process executes said third specific instruction, a signal handler to be paired with an identifier of said process and a kind of signal received by said process with reference to said signal handler storing unit;
a security level changing processing of changing said attribute value of said process after acquisition of a signal handler by said signal handler obtaining processing; and
a security level returning processing of changing, when said process executes said fourth specific instruction, said attribute value of said process to an attribute value as of before change.

20. A computer readable medium storing a program implemented in an information processing device which executes a process under the control of an OS, wherein
said information processing device includes a storage device holding a function for executing a first specific instruction before execution of a processing section whose normal execution might be hindered by unexpected processing of a signal handler and executing a second specific instruction immediately after execution of said processing section, a signal handler hook function for executing a third specific instruction, executing a signal handler starting at an address obtained by the third specific instruction and executing a fourth specific instruction after execution of the signal handler, said signal handler, an attribute value of a process, a signal handler table shared by a plurality of processes, and a signal handler storing unit for saving a pair of a process identifier group including an identifier of a process and a signal handler table, wherein
said program causing said information processing device to execute processing of:
a signal handler changing processing of, when a specific process among a plurality of processes sharing said signal handler table executes said first specific instruction, if no process identifier group including an identifier of other process is stored in said signal handler storing unit, after saving a pair of a process identifier group including an identifier of said specific process and said signal handler table into said signal handler storing unit, changing said signal handler set at said signal handler table to said signal handler hook function, and if a process identifier group including the identifier of said other process is stored in said signal handler storing unit, adding the identifier of said specific process to the process identifier group including the identifier of said other process, as well as adding said signal handler set at said signal handler table to a signal handler table in said signal handler storing unit which table is to be paired with said added process identifier group and thereafter changing said signal handler set at said signal handler table to said signal handler hook function;
a signal handler returning processing of, when said specific process executes said second specific instruction, if no process identifier group including an identifier of said other process is stored in said signal handler storing unit, after returning a signal handler for which said signal handler hook function is set in said signal handler table of said specific process to said signal handler as of before setting of said signal handler hook function which is saved in said signal handler storing unit, deleting data of a pair of a process identifier group including an identifier of said specific process and said signal handler table from said signal handler storing unit, and if a process identifier group including the identifier of said other process is stored in said signal handler storing unit, adding said signal handler set at said signal handler table of said specific process to a signal handler table in said signal handler storing unit which table is to be paired with said process identifier group to delete the identifier of said specific process from said process identifier group;
a signal handler obtaining processing of obtaining, when said process executes said third specific instruction, a signal handler to be paired with an identifier of said process and a kind of signal received by said process with reference to said signal handler storing unit;
a security level changing processing of changing said attribute value of said process after acquisition of a signal handler by said signal handler obtaining processing; and
a security level returning processing of changing, when said process executes said fourth specific instruction, said attribute value of said process to an attribute value as of before change.
